(19) United States
(12) Patent Application Publication
(10) Pub. No.: US 2025/0205995 A1
(43) Pub. Date: Jun. 26, 2025

(54) METHODS OF PREPARING GYPSUM BOARD USING CELLULOSIC FIBER

(71) Applicant: United States Gypsum Company, Chicago, IL (US)

(72) Inventors: Mark Kenneth HEMPHILL, Hawthorn Woods, IL (US); Annamaria VILINSKA, Chicago, IL (US); Gregory Kin Yum, Gurnee, IL (US)

(73) Assignee: United States Gypsum Company, Chicago, IL (US)

(21) Appl. No.: 18/972,774

(22) Filed: Dec. 6, 2024

Related U.S. Application Data
(60) Provisional application No. 63/612,842, filed on Dec. 20, 2023.

(51) Int. Cl. B32B 13/08; B32B 37/15

(52) U.S. Cl. CPC B32B 13/08; B32B 37/15; B32B 2260/021; B32B 2260/044; B32B 2262/04; B32B 2262/101; B32B 2307/72; B32B 2315/06

(57) ABSTRACT

Disclosed are methods of preparing gypsum boards using cellulosic fiber. A set gypsum core is formed and disposed between face and back covers sheets. The set gypsum core is formed from a core slurry comprising stucco, water, cellulosic fiber, and optional additives, such as foaming agent, accelerator, retarder, dispersant, etc. A face dense layer formed from a dense layer slurry comprising stucco, water, and cellulosic fiber is disposed between the core and the face paper. If desired, a back dense layer formed from dense layer slurry can be disposed between the core and the back paper. In embodiments, cellulosic fiber is added to water to form a suspension. The suspension is introduced, while in a non-laminar state, into the core layer and dense layer slurries. Further disclosed is apparatus, such as an extractor and an additive injection system, which can be a part of a cementitious slurry mixing and dispensing assembly.

### CROSS-REFERENCE TO RELATED APPLICATIONS

This application claims priority to U.S. Patent Application No. 63/612,842, filed on Dec. 20, 2023, which is hereby incorporated by reference.

### BACKGROUND

Set gypsum is a well-known material that is used in many products, including panels and other products for building construction and remodeling. One such panel (often referred to as gypsum board) is in the form of a set gypsum core sandwiched between two cover sheets (e.g., paper-faced board) and is commonly used in drywall construction of interior walls and ceilings of buildings. One or more dense layers, often referred to as “skim coats” may be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum primarily in the form of calcium sulfate hemihydrate) and then rehydrated to form set gypsum in a desired shape (e.g., as a board). During manufacture of the board, the stucco, water, and other ingredients as appropriate are mixed, typically in a wallboard slurry mixer as the term is used in the art. A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like. The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. The calcined gypsum reacts with the water in the wallboard preform and sets as a conveyor moves the wallboard preform down a manufacturing line. The wallboard preform is cut into segments at a point along the line where the preform has set sufficiently. Heat is typically used (e.g., in a kiln) to drive off the remaining free (i.e., unreacted) water to yield a dry product.

Reducing the density of the board is of significant interest as long as sufficient strength is maintained. To reduce weight, mass can be removed from the volume of the board and replaced with, e.g., voids, such as air voids created from foam as well as water voids caused by evaporation of water in excess of the amount needed for the rehydration of stucco to gypsum. Perlite and other lightweight filler can also be used as an alternative or supplement to the air and water voids. Lesser weight board is easier to handle, transport, and install, allowing for desired efficiencies in the installation of the board. While lighter weight board is desired, it should not be at the expense of achieving board strength desired by consumers. As mass is removed from the board, it is a challenge to maintain sufficient strength and integrity in the board.

Prior devices and methods for addressing some of the operational problems associated with the production of gypsum wallboard are disclosed in commonly-assigned U.S. Pat. Nos. 5,683,635; 5,643,510; 6,494,609; 6,874,930; 7,007,914; and 7,296,919, which are incorporated by reference. There is a continued need in the art to provide additional solutions to enhance the production of cementitious boards.

It will be appreciated that this background description has been created to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### BRIEF SUMMARY

The present disclosure is premised, at least in part, on the inclusion of cellulosic fiber, and optionally glass fiber, in a board core slurry and/or dense layer slurry (skim coat slurry) prior to the slurries being laid down and assembled in a bonding relation in a sandwich structure of a gypsum board. Surprisingly and unexpectedly, strength in the resulting board can be improved with the use of a relatively small amount of total fiber (e.g., 3% by weight of the stucco or less, such as 2% by weight of the stucco or less) in the core and dense layer slurry. In some embodiments, the amount of cellulosic fiber in the core slurry relative to the dense layer slurry is in a ratio of 1:1 by weight of the stucco. If desired, the dense layer slurry can be formulated to have a higher concentration of the cellulosic fiber as compared with the core slurry. For example, in some embodiments, the dense layer slurry can have cellulosic fiber in an amount of 1% to 2% by weight of the stucco and the core slurry can have cellulosic fiber in an amount of 0.5% to 1% by weight of the stucco. Surprisingly and unexpectedly, the use of the cellulosic fiber in the core and/or dense layer slurries can allow for board with good strength (e.g., having a nail pull of at least 65 lb (such as 72 lb) according to ASTM 473-10) at low board weights (e.g., having a board density of 32 pcf or less, such as 30 pcf or less). The use of the cellulosic and/or glass fiber further allows for preparation of such board with good strength while reducing the amount of strength-enhancing starch (non-migrating starch such as pre-gelatinized starch or cooked starch) in some embodiments.

Thus, in one aspect, the present disclosure provides a method of making gypsum board. The method comprises the preparation of a slurry comprising water, stucco, and cellulosic fiber in an amount of 2% or less by weight of the stucco in a mixer. A majority portion of the slurry is then discharged from the mixer (e.g., through a main discharge conduit) to form a core slurry. A minority portion of the slurry is extracted from the mixer (e.g., through a secondary discharge conduit) to form a dense layer slurry. The dense layer slurry is then applied in bonding relation to a first cover sheet. A first surface of the core slurry is applied in bonding relation to the dense layer, A second cover sheet is applied in bonding relation to a second surface of the core slurry. Once prepared, the board can have, e.g., a density of 32 pcf or less (such as 30 pcf or less) and a nail pull resistance of at least 65 lb (such as 72 lb) according to ASTM 473-10, method B.

In another aspect, the present disclosure provides a method of making gypsum board comprising the preparation of a core slurry and a dense layer slurry. In accordance with the method, the core layer slurry is prepared comprising water, stucco, foaming agent, and cellulosic fiber. In embodiments, the amount of strength-enhancing starch can be reduced as compared with the same board prepared without cellulosic fiber in the core and dense layer slurries. For example, in accordance with some embodiments, the strength-enhancing starch is added to the core slurry in an amount of 4% or less by weight of the stucco. The dense layer slurry is prepared comprising water and stucco, with cellulosic fiber being added to the dense layer slurry in an amount 2% by weight of the stucco or less. Once prepared, the dense layer slurry is applied in bonding relation to a first cover sheet. A first surface of the core slurry is applied in bonding relation to the dense layer and a second cover sheet is applied in bonding relation to a second surface of the core slurry. Once prepared, the board can have, e.g., a density of 32 pcf or less (such as 30 pcf) or less and a nail pull resistance of at least 65 lb (such as 72 lb) according to ASTM 473-10, method B.

In a further aspect, the present disclosure provides a method of making gypsum board comprising the preparation of a core slurry and a dense layer slurry. In accordance with the method, the core slurry is prepared comprising water, stucco, foaming agent, and cellulosic fiber in an amount of 0.5% to 1.5% by weight of the stucco (e.g., from 0.5% to 1%, such as from 0.6% to 1.5% or 0.65% to 1%, etc.). The dense layer slurry comprises water and stucco and excluding foaming agent. Cellulosic fiber is added to the dense layer slurry in an amount of 0.7% to 2% by weight of the stucco (e.g., from 1% to 2%, such as from 1.2% to 2%, 1.4% to 1.8%, 1,5% to 1.7%, etc.). Once prepared, the dense layer is applied in bonding relation to a first cover sheet. A first surface of the core slurry is applied in bonding relation to the dense layer and a second cover sheet is applied in bonding relation to a second surface of the core slurry. The dense layer slurry preferentially contains a greater concentration of the cellulosic fibers than the core slurry and includes the same or lower amount of starch, dispersant, accelerator, retarder, and polyphosphate, as compared with the core slurry. Once prepared, the board can have, e.g., a density of 32 pcf or less (such as 30 pcf or less) and a nail pull resistance of at least 65 lb (such as 72 lb) according to ASTM 473-10, method B.

In a further aspect, the present disclosure provides a method of making gypsum board comprising the preparation of a core slurry and a dense layer slurry. In accordance with the method, the core slurry is prepared comprising water, stucco, foaming agent, and cellulosie fiber (e.g. in an amount of 0.5% to 1,5% by weight of the stucco, such as from 0.5% to 1%, from 0.6% to 1.5% or 0.65% to 1%, etc.). The dense layer slurry comprises water and stucco and, e.g., optionally excludes foaming agent. Cellulosic fiber is added to the dense layer slurry in an amount of 0.7% to 2% by weight of the stucco, such as from 1% to 2% (such as from 1.2% to 2%, 1.4% to 1,8%, 1.5% to 1,7%, etc.). Once prepared, the dense layer is applied in bonding relation to a first cover sheet. A first surface of the core slurry is applied in bonding relation to the dense layer and a second cover sheet is applied in bonding relation to a second surface of the core slurry. In some embodiments, glass fiber can be included with the cellulose fiber. In some embodiments, the dense layer slurry preferentially contains a greater concentration of the cellulosic and/or glass fibers than the core slurry and includes the same or lower amount of starch, dispersant, accelerator, retarder, and polyphosphate, as compared with the core slurry. Once prepared, the board can have, e.g., a density of 34 pcf or less (such as 32 pcf or less or 30 pcf or less) and a nail pull resistance of at least 65 lb (such as at least 72 lb) according to ASTM 473-10, method B. In some embodiments, cellulosic and/or glass fiber is prepared using a wet pulp containing water and the fiber. In some embodiments, the wet pulp can be mixed in a pulper for an amount of time dependent on the temperature of the water in the wet pulp. In some embodiments, an adjustment coefficient (a) for the relationship between temperature (° F.) and pulping time according to linear regression analysis is from 0 to −0.1, as discussed herein.

Further and alternative aspects and features of the disclosed principles will be appreciated from the following detailed description and the accompanying drawings. Accordingly, it is to be understood that both the foregoing general description and the following detailed description are exemplary and explanatory only and do not restrict the scope of the appended claims.

### BRIEF DESCRIPTION OF THE DRAWINGS

FIG. 1A is a flow diagram of the process for delivering cellulosic fiber in wet form (“pulp”) to the board assembly, using a hydrapulper to form the cellulosie fiber pulp according to embodiments of the present disclosure.

FIG. 1B is a flow diagram of the process for delivering cellulosic fiber in dry form to the board assembly, using a hammer mill to form the dry form of the cellulosic fiber according to embodiments of the present disclosure.

FIG. 1C is a flow diagram of the process for delivering cellulosic fiber in wet form and/or dry form to the board assembly, using a hydrapulper to form the cellulosic fiber pulp and/or a hammer mill to form the dry form of the cellulosic fiber according to embodiments of the present disclosure.

FIG. 2 is an elevational view of the hydrapulper according to embodiments of the present disclosure.

FIG. 3 is a perspective view of an embodiment of a mixer extractor assembly constructed in accordance with embodiments of the present disclosure.

FIG. 4 is an end elevational view of the mixer extractor assembly of FIG. 3 with an additive injection system in section along a plane transverse to a longitudinal axis of the mixer extractor assembly.

FIG. 5 is an end elevational view of an additive injection body of the additive injection system of FIG. 4, showing for illustrative purposes the additive injection body partially in section.

FIG. 6 is a cross-sectional view of the additive injection body of FIG. 5 taken along line IV-IV in FIG. 5.

FIG. 7 is a perspective view, from a first end thereof, of another embodiment of an additive injection system constructed according to embodiments of the present disclosure.

FIG. 8 is a perspective view, from a second end thereof, of the additive injection system of FIG. 7.

FIG. 9 is a longitudinal cross-sectional view of the additive injection system of FIG. 7.

FIG. 10 is a perspective view of another embodiment of an additive injection body constructed according to embodiments of the present disclosure.

FIG. 11 is side elevational view, in section, of the additive injection body of FIG. 10.

FIG. 12 is a perspective view of an additive injection block of the additive injection body of FIG. 10.

FIG. 13 is a perspective view of an inlet portion of the additive injection body of FIG. 10.

FIG. 14 is a perspective view of an outlet portion of the additive injection body of FIG. 10.

FIG. 15 is a schematic plan diagram of an embodiment of a cementitious sharry mixing and dispensing assembly, including an embodiment of a mixer extractor assembly constructed in accordance with embodiments of the present disclosure respectively incorporated into a pair of secondary discharge conduits.

FIG. 16 is a schematic elevational diagram of an embodiment of a wet end of a gypsum wallboard manufacturing line including an embodiment of a mixer extractor assembly constructed in accordance with embodiments of the present disclosure respectively incorporated into a pair of secondary discharge conduits.

FIG. 17A illustrates an injection port with an inner diameter of 1″ in accordance with embodiments of the disclosure.

FIG. 17B illustrates an injection port with an inner diameter of 0.504″ in accordance with embodiments of the disclosure.

FIG. 17C illustrates an injection port with an inner diameter of 0.374″ in accordance with embodiments of the disclosure.

FIG. 17D illustrates an injection port with an inner diameter of 0.227″ in accordance with embodiments of the disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

Embodiments of the disclosure provide methods of making gypsum board. The gypsum boards produced by the disclosed methods comprise set gypsum (referred to as the “set gypsum core” or “core”) sandwiched between face and back cover sheets. A dense layer (referred to as a “skim coat”) is disposed between the set gypsum core and the face cover sheet. In some embodiments, a second dense layer is disposed between the set gypsum core and the back cover sheet.

In accordance with some embodiments of the disclosure, water, stucco, cellulosic fiber, and other ingredients as desired are combined and mixed in a mixer (e.g., a pin mixer or pin-less mixer). In embodiments, the amount of total fiber added to the mixer is 3% by weight of the stucco or less (e.g., from 0.5% to 2%, from 0.6% to 2%, from 0.8% to 2%, from 1% to 2% by weight of the stucco, from 0.5% to 3% by weight of the stucco, etc.). A majority portion (i.e., greater than 50%) of the slurry is discharged through a discharge conduit to form a core slurry. A minority portion (i.e., less than 50%) of the slurry is extracted from the mixer to form a dense layer slurry. In the case of multiple dense layers, more than one extractor can be used if desired. Alternatively, in some embodiments, a single extractor can be deployed with multiple outlets to form the dense layer slurries for the face and back skim coat layers, respectively. Alternatively, if desired, in some embodiments, more than one extractor can be deployed to form the dense layer slurries for the face and back skim coat layers, respectively. In some embodiments, no additional cellulosic fiber is added to the discharge conduit and/or to the extractors, such that the core slurry and the dense layer slurry have the same amount of cellulosic fiber (i.e., a 1:1 weight ratio). In some embodiments, the full source of the cellulosic fiber in both the core slurry and dense layer slurry is sourced from what was added to the mixer.

Optional additives include, e.g., foaming agent, accelerator, retarder, polyphosphate, etc. The formulations of the core slurry and dense layer slurry can be tailored to accommodate desired quantities of such ingredients by including such ingredients in the discharge conduit and/or extractor, in addition to the mixer. For example, foaming agent can be added to the discharge conduit and not into the mixer or the extractor, so that the core slurry has foaming agent and the sense layer excludes it. However, if desired, some foaming agent can be added to the extractor or the mixer so that there is some foam in the dense layer slurry as desired.

In methods according to embodiments of the disclosure, a board having a sandwich structure as known in the art is formed. In the sandwich structure, the core slurry forms a set gypsum core disposed between face and back cover sheets, respectively. A dense layer slurry (i.e., a skim coat slurry) is disposed between the core and one of the cover sheets. If desired, optionally, a dense layer slurry is further disposed between the core and the other cover sheet.

Embodiments of the disclosure have particular utility in producing gypsum board with good strength properties at low board weights. For example, in embodiments, the board can have a nail pull resistance of at least 65 lb (such as at least 72 lb, at least 77 lb, etc.) according to ASTM 473-10, method B, even at low board weights. For example, in some embodiments, the board has a density of 30 pcf or less (e.g., from 15 pcf to 30 pcf, or from 20 pcf to 30 pcf, etc.). Surprisingly and unexpectedly, it has been found that the presence of the cellulosic fiber, even in relatively low quantities (e.g., 2% by weight of the stucco or less) allows for good strength properties at such low board weights while also allowing the core and/or dense layer slurries to be formulated with less strength-enhancing starch (e.g., in an amount of 4% or less by weight of the stucco).

In some embodiments, particularly where stucco purity is relatively high (e.g., 93% or higher) the amount of strength-enhancing starch can particularly be reduced. When lower purity stucco is used, it may be beneficial to increase the presence of strength-enhancing starch with the cellulosic fiber. For example, when the purity is below 93% (e.g., from 80% to 93%), the amount of strength-enhancing starch can be 10% higher (e.g., from 4% to 4% by weight of the stucco) than when the purity is 93% or higher.

The fiber can be introduced into the dense layer slurry in the form of a wet pulp containing water and the fiber. A pulper can be used to prepare the pulp. Generally, the pulper contains a rotor. There are different types of rotors, depending on the types of fiber (e.g. paper), the consistency and the size of the pulping tank. The rotor design is responsible for beating the dry fiber (e.g. paper) into water and for creating a vortex of pulp which increases shearing forces. While the rotor is responsible for creating the vortex, it is the fiber-on-fiber or flake-on-flake shearing forces that break down the material further. The consistency is relevant because higher consistencies mean the fibers are closer together but higher consistencies also change the theology of the pulp. Different pulps are composed of different types of fiber. Every type of fiber breaks down differently, depending on how it was made and processed. Suitable pulper devices are commercially available from manufacturers such as Voith Group (Heidenheim an der Brenz, Germany), Valmet Oyj (Espoo, Finland), Kadant Inc. (Westford MA), and Andritz AG (Graz, Austria).

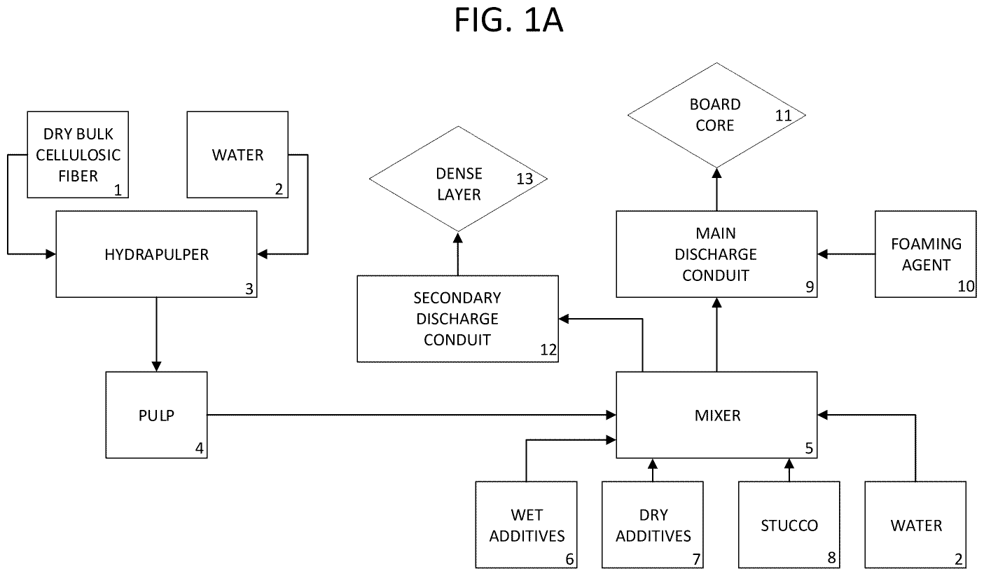

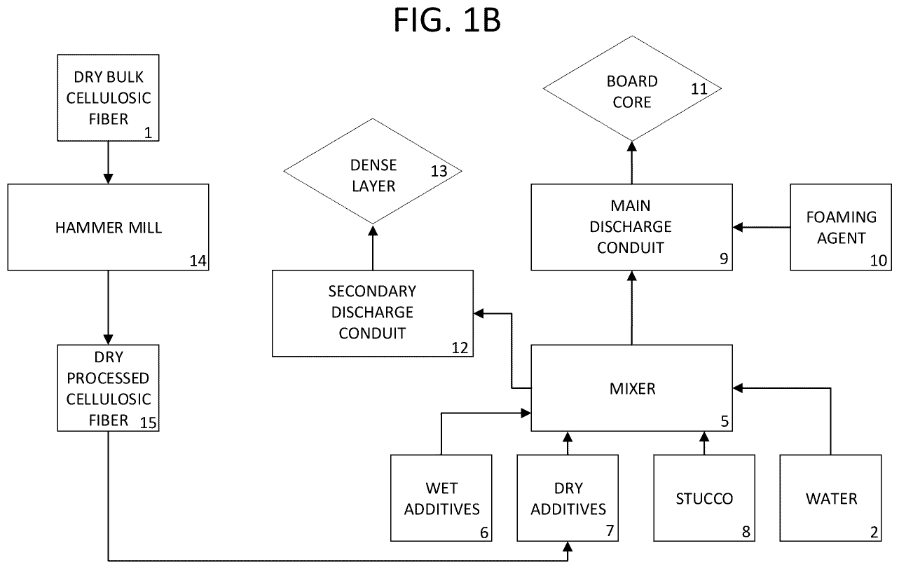

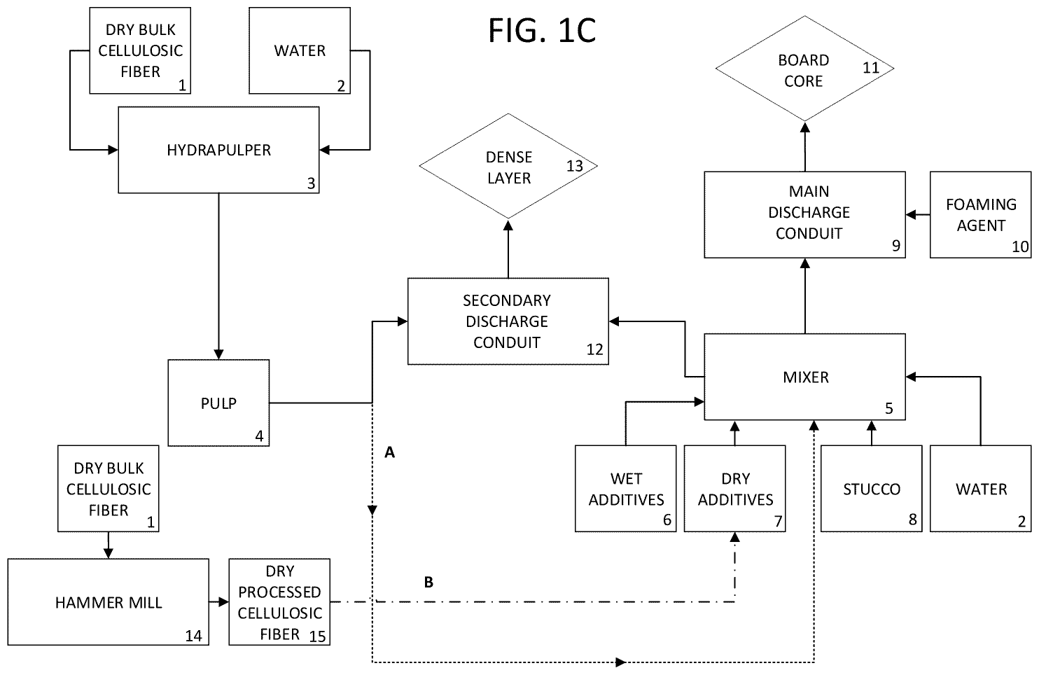

Flow diagrams of board layer assembly systems used according to principles of the present disclosure are shown in FIGS. 1A, 1B, and 1C. The systems represented by the flow diagrams are suitable for use in embodiments of the following principles of the present disclosure. Referring to FIG. 1A, in the illustrated flow diagram, the process for delivering cellulosic fiber in wet form is depicted. Embodiments of the process comprise initially adding a dry bulk cellulosic fiber 1 and a water 2 to a hydrapulper 3. A pulp 4 is prepared by the hydrapulper 3. The pulp 4 is added to a mixer 5. Other ingredients are also added to the mixer 5; including wet additives 6, dry additives 7, stucco 8, and the water 2. A majority portion of the slurry inside the mixer 5 flows to a main discharge conduit 9. A foaming agent 10 is added to the main discharge conduit 9. The contents of main discharge conduit 9 are used to prepare a resulting board core 11. A minority portion of the slurry inside the mixer 5 flows to a secondary discharge conduit 12. The slurry in the secondary discharge conduit 12 is used to form a resulting dense layer 13. The board core 11 and the dense layer 13 are assembled in the form of a board as described herein.

Referring to FIG. 1B, in the illustrated flow diagram, the process for delivering cellulosic fiber in dry form is depicted. Embodiments of the process comprise initially adding a dry bulk cellulosic fiber 1 to a hammer mill 14. A dry processed cellulosic fiber 15 is prepared by the hammer mill 14. The dry processed cellulosic fiber 15 is then added to dry additives 7. Once added, the dry additives 7 are fed into a mixer 5, along with wet additives 6, stucco 8, and water 2. A majority portion of the slurry inside the mixer 5 flows to a main discharge conduit 9. A foaming agent 10 is added to the main discharge conduit 9. The contents of the main discharge conduit 9 are used to prepare a resulting board core 11. A minority portion of the slurry inside the mixer 5 flows to a secondary discharge conduit 12. The slurry in the secondary discharge conduit 12 is used to form a resulting dense layer 13. The board core 11 and the dense layer 13 are assembled in the form of a board as described herein.

FIG. 1C depicts, as an illustrated flow diagram, the process for delivering cellulosie fiber in wet form and/or dry form (depicted as optional methods (A) and (B), respectively). Embodiments of the process involve adding a dry bulk cellulosic fiber 1 and a water 2 to a hydrapulper 3. A pulp 4 is prepared by the hydrapulper 3. The pulp 4 is added to a secondary discharge conduit 12 to be used in the formation of a resulting dense layer 13. In accordance with optional method (A), the pulp 4 is added to a mixer 5. Other ingredients are also added to the mixer 5; including wet additives 6, dry additives 7, stucco 8, and the water 2. A majority portion of the slurry inside the mixer 5 flows to a main discharge conduit 9. A foaming agent 10 is added to the main discharge conduit 9. The contents of the main discharge conduit 9 are used to prepare a resulting board core 11. A minority portion of the slurry inside the mixer 5 flows to the secondary discharge conduit 12. The slurry in the secondary discharge conduit 12 is used to form the resulting dense layer 13. The board core 11 and the dense layer 13 are assembled in the form of a board as described herein.

In accordance with optional method (B), the dry bulk cellulosic fiber 1 is added to a hammer mill 14. A dry processed cellulosic fiber 15 is prepared by the hammer mill 14. The dry processed cellulosic fiber 15 is then added to the dry additives 7. Once added, the dry additives 7 are placed in the mixer 5, along with the wet additives 6, the stucco 8, and the water 2. A majority portion of the slurry inside the mixer 5 flows to the main discharge conduit 9. The foaming agent 10 is added to the main discharge conduit 9. The contents of the main discharge conduit 9 are used to prepare the resulting board core 11. A minority portion of the slurry inside the mixer 5 flows to the secondary discharge conduit 12. The slurry in the secondary discharge conduit 12 is used to form the resulting dense layer 13. The board core 11 and the dense layer 13 are assembled in the form of a board as described herein.

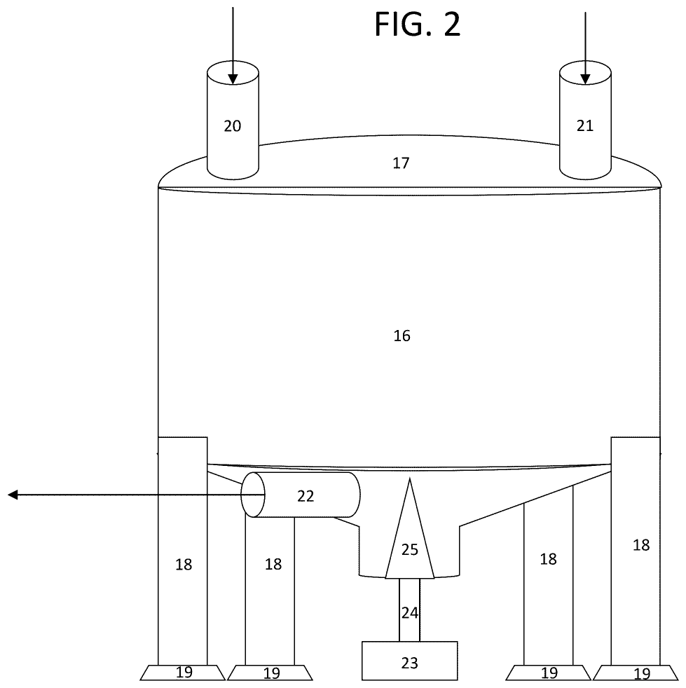

An embodiment of a hydrapulper 3, used to produce fiber pulp from waste paper (including, e.g., waste paper), constructed according to principles of the present disclosure is shown in FIG. 2. The structure of the hydrapulper 3 comprises a tank body 16 with a tank lid 17 and supporting legs 18. The supporting legs 18 are secured to the ground (e.g., factory floor) by bracing plates 19. Tank body 16 includes several inlet and outlet pipes, including a fiber inlet 20, a water inlet 21, and a pulp fiber outlet 22. The fiber inlet 20 introduces bulk, unprocessed fiber (e.g., waste paper) to the tank body 16 and the water inlet 21 introduces water to the tank body 16. The pulp fiber outlet 22 allows for the removal of processed pulp fiber from the tank body 16.

The operation of the hydrapulper 3 is powered by a motor 23 which is directly located beneath the tank body 16. The motor 23 is connected to an impeller 24, A blade assembly 25 is connected to the other end of the impeller 24 and can be located at the bottom of the tank body 16. When powered, the motor 23 rotates the impeller 24, which spins the blade assembly 25 within the tank body 16.

The contents of the tank body 16 (e.g., water and fiber) can be added in any order (e.g., water can be added prior to the addition of fiber) and in any suitable amount. For example, in some embodiments, half of the volume of the tank body 16 or less can be filled with water to prepare fiber pulp with certain desired properties (e.g., consistency). To illustrate the operation of an embodiment of the hydrapulper 3, initially, an amount of water is added to the tank body 16 via the water inlet 21 and an amount of fiber (e.g., waste paper) is added to the tank body 16 via fiber inlet 20. The blade assembly 25, when rotated by the motor 23 and the impeller 24, causes the contents of the tank body 16 to circulate rapidly. The circulation produces shear force. The shear force produced by the circulation of the contents of the tank body 16, inter alia, encourages the rapid separation of the fiber suspended in the water. Friction with the other fibers, shear force, and physical contact with the blade assembly 25 distributes fiber throughout the water, thereby producing fiber pulp. Once processed, the fiber pulp is then removed from the tank body 16 via the pulp outlet 22. A dedicated pulp can be used to deliver the pulp into the dense layer slurry.

In accordance with some embodiments, the present inventors have discovered that, surprisingly and unexpectedly, it is beneficial to mix the pulp for a longer period of time when lower temperatures of the water are used in preparing the pulp. For example, preferably, the temperature of the water is at or near room temperature or warmer, e.g., from 18° C. to 35° C., such as from 18° C. to 30° C., from 18° C. to 25° C., from 18° C. to 23° C., from 20° C. to 25° C., or from 20° C. to 23° C. However, ambient conditions may require the use of colder water (sometimes significantly so) when forming the pulp, such as in winter season in colder climates. As the temperature of the water used in preparing the pulp decreases, the amount of time used in mixing the pulp is increased in accordance with some embodiments of the disclosure.

The wet pulp can be mixed for any suitable amount of time, e.g., from 5 minutes to 50 minutes, with shorter durations generally used when the water used in making the pulp is on the warmer side (e.g., near room temperature or higher) and longer durations generally used for water at colder temperatures (e.g., below room temperature and lower). Precise mixing times can be adjusted by one of ordinary skill in the art, depending on the pulp consistency and composition, as well as the pulper and rotor type and design. In some embodiments, the mixing time is from 5 minutes to 40 minutes, 5 minutes to 30 minutes, 5 minutes to 20 minutes, 5 minutes to 10 minutes, from 10 minutes to 50 minutes, from 10 minutes to 40 minutes, 10 minutes to 30 minutes, 10 minutes to 20 minutes, 10 minutes to 15 minutes, from 20 minutes to 50 minutes, from 20 minutes to 40 minutes, 20 minutes to 30 minutes, 30 minutes to 50 minutes, 30 minutes to 40 minutes, 40 minutes to 50 minutes, etc.

In accordance with some embodiments, linear regression analysis can be used to determine the adjustment coefficient (α) that quantifies the relationship between pulping temperature (° F.) and the pulping time. It is understood that linear regression is a statistical technique that models the relationship between an independent variable (in this case, temperature) and a dependent variable (pulping time) by fitting a linear equation to observed data. To derive the coefficient, experimental data can be collected at various temperatures and normalized relative to a reference temperature of 65° F. The normalized pulping times are then plotted against the temperature (° F.) differences, enabling the calculation of the slope of the linear regression line, which corresponds to the adjustment coefficient. This approach allows for a characterization of how temperature is associated with pulping time. According to this model, as temperature decreases, there is an associated increase in pulping time, e.g., as characterized by the adjustment coefficient.

In accordance with some embodiments, the adjustment coefficient according to linear regression analysis is generally from 0 to −0.1, such as from 0 to −0.05, from 0 to −0,033, from 0 to −0.019, from 0 to −0.0025, from 0 to −0.0009, from −0.019 to −0.033, from −0.0009 to −0.0025, from −0.0005 to −0.003, from −0.01 to −0.03, from −0.01 to −0.02, from −0.0009 to −0.033, or from −0,0025 to −0.033, etc. One of ordinary skill in the art will recognize that the adjustment coefficient may vary depending on the specific hydrapulper device and the pulp consistency used. In this context, consistency refers to the percentage of fiber content in the pulping mixture, which impacts the interaction between temperature and mixing time. For instance, at approximately 5% pulp consistency, in some embodiments the adjustment coefficient can range from −0.019 to −0.033, indicating that each degree Fahrenheit decrease in temperature is associated with an increase in pulping time by 1,9% to 3.3%. By contrast, for example, at a lower consistency of approximately 3.2%, in some embodiments, the coefficient can range from −0.0009 to −0.0025, reflecting significantly reduced sensitivity to temperature changes.

In accordance with embodiments of the disclosure, the gypsum board includes cellulosic fiber in the board core and dense layer slurries. The cellulosic fibers in the core layer and/or core layer slurries can be of any suitable composition and dimension for enhancing strength in the board. For example, the cellulosic fibers can include any suitable source of fibers, including paper fibers, wood fibers, straw fibers, grass fibers, cotton fibers, and/or rayon fibers. For example, in some embodiments, the grass fiber included in the cellulosic fiber can be in the form of bamboo fiber, hemp fiber, jute fiber, and/or kenaf fiber. The cellulosic fiber can also be sourced from recycled fibers and/or waste fibers.

The cellulosic fibers can have any suitable length and diameter. For example, in some embodiments, the cellulosic fibers have a length of at least 500 microns (e.g., between 500 microns to 2000 microns, from 700 microns to 2000 microns, from 1000 microns to 2000 microns, from 1200 microns to 2000 microns, from 1500 microns to 2000 microns, from 1700 microns to 2000 microns, from 500 microns to 1700 microns, from 500 microns to 1500 microns, from 500 microns to 1200 microns, from 500 microns to 1000 microns, from 500 microns to 700 microns, etc.). In embodiments, the cellulosic fibers can be micro- or nano-fibers at any suitable average length, such as under 100 microns or less (e.g., between 10 microns to 100 microns, 20 microns to 100 microns, 40 microns to 100 microns, 60 microns to 100 microns, 80 microns to 100 microns, 10 microns to 80 microns, 10 microns to 60 microns, 10 microns to 40 microns, 10 microns to 20 microns, etc.).

For example, in some embodiments, the cellulosic fibers have a diameter of at least 1 micron, such as at least 10 microns, at least 20 microns, etc. (e.g., from 1 micron to 40 microns, from 10 microns to 40 microns, from 10 microns to 30 microns, from 15 microns to 40 microns, from 15 microns to 30 microns, from 20 microns to 40 microns, from 20 microns to 30 microns, etc.).

In some embodiments, the cellulosic fiber contains long fibers or flakes. Fibers that are long are defined herein as not passing through the mesh of a U14 Clark Classifier. Similarly, as defined herein, a flake is a bundle of non-separated fibers that will not pass through the mesh of U14 Clark Classifier. The Technical Association of the Pulp and Paper Industry (TAPPI) standard for the U14 Clark: Classifier is TAPPI Standard T-233 (2006 Edition). The U.S. standard 14 sets forth an opening size in the mesh of 1.41 mm.

In some embodiments, the cellulosic fibers include paper fibers. Any suitable source of paper can be used for the paper fibers. For example, the paper fiber can be chopped. For example, the paper fibers can be sourced from recycled waste paper, such as old corrugated carton (OCC). In some embodiments, the cellulosic fibers include wood fibers (e.g., wood pulp fibers). For example, the wood pulp fibers can include softwood and hardwood pulp fibers.

In some embodiments, the cellulosic fibers include straw fibers. For example, the straw fibers can include fibers from cereal grain grasses, such as wheat, rye, and barley. In some embodiments, the cellulosic fibers include cotton fibers and/or rayon fibers. In some embodiments, the cellulosic fibers include grass fibers. For example, the grass pulp fibers include fibers sourced from hemp, jute, kenaf, and bamboo pulp fibers, cotton pulp fibers or any combination thereof.

The cellulosic fiber can be added to the core layer and/or dense layer slurries in any suitable amounts. In embodiments, the dense layer slurry preferentially contains a greater concentration of the cellulosic fibers than the core lay slurry. For example, in accordance with some embodiments, the weight ratio of the cellulosic fiber provided in the dense layer slurry relative to the core slurry is at least 1.2, such as at least 1.8, at least 2, at least 2.2, e.g., such as from 1.2 to 4.5, from 1.2 to 4, from 1.2 to 3, from 1,2 to 2.5, from 1.2 to 2,3, from 1.5 to 4,5, from 1.5 to 4, from 1.5 to 3, from 1.5 to 2.5, from 1.5 to 2.3, from 1.8 to 4.5, from 1.8 to 4, from 1.8 to 3, from 1.8 to 2.5, from 1.5 to 2.3, from 2 to 4.5, 2 to 4, from 2 to 3, from 2 to 2,5, from 2.2 to 4.5, such as from 2.2 to 4, from 2.2 to 3, or from 2.2 to 2.5.

In accordance with the teachings of the present specification, the cellulosic fiber can be added to the core slurry in an amount of 0.5% to 1% by weight of the stucco. Further, the cellulosic fiber can be added to the dense layer slurry in an amount of 2% by weight of the stucco or less, such as 1.5% or less, 0.5% to 1.5%. In some embodiments, the dense layer slurry contains from 1.3% to 1 of cellulosic fiber by weight of the stucco, and the core slurry contains from 0.5% to 0.8% of cellulosic fiber by weight of the stucco.

The cellulosic fiber can be added to the core layer and/or dense layer slurries in dry form. In accordance with teachings of the present specification, in some embodiments, the dry form of the cellulosic fiber is hammer milled.

The cellulosic fiber can be added to the core layer and/or dense layer slurries by injection of a wet pulp. In accordance with teachings of the present specification, in some embodiments, the wet pulp contains from 0.5% to 10%, such as from 1% to 6%, or from 2% to 5%, of cellulosic fiber in water. In some embodiments, the wet pulp is prepared in a hydrapulper. In embodiments, the wet pulp is injected into the dense layer slurry and/or core slurry via one or more injection hose producing flow of the pulp sufficient to form enough shear force in the injection hose to uniformly distribute the cellulosic fiber in dense layer slurry and/or core slurry.

In some embodiments, the fiber component can include a combination of cellulosic fiber and glass fiber (fiberglass). In some embodiments, surprisingly and unexpectedly, the combination of the cellulosic and glass fibers can result in enhanced strength (e.g. by surprisingly strengthening the fiber network). The glass fiber can be included in any suitable amount, relative to the amount of paper fiber, in the dense layer and/or core slurry. For example, in some embodiments, the glass fiber is included in an amount of from 0 to 1% by weight of the stucco, such as from 0.1% to 1%, 0.1% to 0.7%, from 0.1% to 0.5%, from 0.2% to 1%, from 0.2% to 0.7%, from 0.2% to 0.5% by weight of the stucco, etc. For example, in some embodiments, the weight ratio of cellulosic fiber to fiberglass can be from 1:1 to 5:1, such as from 1.5:1 to 5:1, from 1,5:1 to 4:1, from 1,5:1 to 3:1, from 1.5:1 to 2:1, from 2:1 to 5:1, from 2:1 to 3:1, from 3:1 to 5:1, from 3:1 to 4:1, etc. The fiberglass can be selected using any suitable dimensions. For example, in some embodiments, the glass fibers have a relatively thin diameter (e.g., 100 microns or less) such as a diameter of 1 micron to 50 microns, e.g., from 5-50 microns, 5-40 microns, 5-30 microns, 5-20 microns, 5-10 microns, 10-50 microns, 10-40 microns, 10-30 microns, 10-20 microns, 20-50 microns, 20-40 microns, 20-30 microns, 30-50 microns, 30-40 microns, 40-50 microns, etc. In some embodiments, the glass fibers have a length of at least 1 mm and can be a length of at least 50 mm, e.g. from 5-50 mm, 5-40 mm, 5-30 mm, 5-20 mm, 10-50 mm, 10-40 mm, 10-30 mm, 10-20 mm, 20-50 mm, 20-40 mm, 20-30 mm, 30-50 mm, 30-40 mm, 40-50 mm, etc.

In accordance with embodiments of the disclosure, the gypsum board includes a board core comprising set gypsum sandwiched between face and back cover sheets with a dense layer disposed between the board core and the face cover sheet. The board core and dense layer slurries are formulated differently. Cellulosic fiber is included in both the core and the dense layer but the fiber is included in a higher concentration in the dense layer as described herein.

The core and dense layer slurries, respectively, contain water and stucco (or other cementitious material as mentioned herein). Stucco is sometimes referred to as calcined gypsum, and it can be in the form of calcium sulfate alpha hemihydrate, calcium sulfate beta hemihydrate, and/or calcium sulfate anhydrite. The calcined gypsum can be fibrous in some embodiments, nonfibrous in other embodiments, or a combination thereof in other embodiments, In embodiments, the calcined gypsum can include at least 50% beta calcium sulfate hemihydrate. In other embodiments, the calcined gypsum can include at least 86% beta calcium sulfate hemihydrate. While the use of stucco and calcium sulfate dihydrate (“gypsum,” “set gypsum,” or “hydrated gypsum”) is illustrated herein, it will be understood that other cementitious materials may be used in addition or as an alternative, to stucco. Non-limiting examples of other cementitious materials include portland cement, sorrel cement, slag cement, fly ash cement, and calcium alumina cement.

The strength-enhancing starch refers to a starch that improves the strength of the board (e.g., with respect to nail pull strength) as compared with the same board excluding the starch in the dense layer. Starches for strength enhancement are discussed in, e.g., U.S. Pat. Nos. 9,540,810, 9,828,441, 10,399,899, and 10,919,808. Any suitable strength-enhancing starch can be used, including hydroxyalkylated starches such as hydroxyethylated or hydroxypropylated starch, or a combination thereof; a pregelatinized starch; or an uncooked, non-migrating, starch.

Any suitable pregelatinized starch can be included in the dense layer slurry, as described in U.S. Pat. Nos. 10,399,899 and 9,828,441, including methods of preparation thereof and desired viscosity ranges described therein. If included, the pregelatinized starch can exhibit any suitable viscosity. In some embodiments, the pregelatinized starch is a mid-range viscosity starch as measured according to the VMA method as known in the art and as set forth in U.S. Pat. No. 10,399,899, which VMA method is hereby incorporated by reference. In other embodiments, the pregelatinized starch has a greater viscosity, such as greater than 700 centipoise (e.g., 773 centipoise) according to the VMA test.

In some embodiments, the starch includes an uncooked starch having (i) a hot water viscosity of from 20 BU to 300 BU according to the hot water viscosity assay (HWVA method), and/or (ii) a mid-range peak viscosity of from 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for 10 minutes, and the starch is cooled to 50° C. at a rate of −3° C./minute as described in U.S. Pat. No. 10,919,808. As referred to herein, combinations of different strength-enhancing starches can also be used in the dense layer slurry if desired.

For example, in some embodiments, the strength-enhancing starch includes an uncooked medium hydrolyzed acid modified starch (e.g., an uncooked acid-modified corn starch having a hot water viscosity of 180 BU); and/or a medium viscosity and medium molecular weight pregelatinized starch (e.g., pregelatinized corn flour starch with a cold water viscosity of 90 centipoise).

Strength-enhancing starches differ from migrating starches such as LC-211, commercially available from Archer-Daniels Midland, Chicago, Illinois. Migrating starches normally have smaller chain lengths (e.g., due to acid- or enzyme-modification) and migrate to the core-cover sheet interface for further bond enhancement. For example, in some embodiments, the core or base slurry includes a migrating starch having a molecular weight of 6,000 Daltons or less.

If included, the optional strength-enhancing starch can be included in the dense layer slurry (and optionally core slurry) in any suitable amount. In some embodiments, the strength-enhancing starch is in the same amount in the dense layer slurry and the core slurry, respectively. However, if desired, in some embodiments more strength-enhancing starch is included in the dense layer slurry. For example, in some embodiments, the dense layer slurry comprises a strength-enhancing starch in an amount of at least 0.5% by weight of the stucco (e.g., from 0.5% to 5% by weight of the stucco, such as from 0.5% to from 1% to 5%, from 1% to 3%, from 2% to 5%, from to 4%, from 2% to 3%, by weight of the stucco, etc.). In some embodiments, the core slurry is substantially free of a strength-enhancing starch, e.g., having 2% or less by weight of stucco, such as 1% or less by weight of the stucco.

In some embodiments, the amount of the strength-enhancing starch is included in the dense layer slurry (and optionally the core slurry) in a weight percentage that is greater than the amount of fiber (i.e., cellulosic and/or glass fiber) that is included. By way of example, the strength-enhancing starch can be provided in an amount that is from 30% to 200% more than the amount of the fiber, e.g., from 33% to 170%, from 33% to 150%, from 33% to 100%, from 50% to 200%, from 50% to 150%, from 50% to 100%, from 75% to 200%, from 75% to 150%, from 75% to 100%, from 100% to 200%, from 100% to 150%, from 100% to 125%, from 150% to 200% etc. In some embodiments, if desired, the strength-enhancing starch can be included in the pulp as a convenient way for dosing, although it can also be added to the core and/or dense layer slurry separately.

In some embodiments, alum can optionally be included in the dense layer slurry (and optionally the core slurry). Surprisingly and unexpectedly, the use of alum can address imbalance in stiffening rates between the core and dense layer slurries, respectively, especially when the core slurry stiffens at a faster rate than the dense layer slurry (e.g., the stiffening time of the core slurry can require 66% or less of the time required for the stiffening of the dense layer slurry, e.g., 55% or less of the time, 50% or less of the time, 45% or less of the time etc.). This imbalance in the stiffening rates between the layers can undesirably cause washout when the layers are formed into the desired sandwich structure. It has been found that the use of alum can enhance the stiffening rate in the dense layer slurry and thereby reduce or avoid washout. If included, the alum can be provided in any suitable amount, and preferably an amount that avoids significant deleterious effect on the nail pull strength in the final board product. For example, in some embodiments, the alum can be included in the dense layer slurry in an amount of at least 0.01% by weight of the stucco (e.g., from 0.01% to 5% by weight of the stucco, such as from 0.1% to 0.5%, by weight of the stucco).

With respect to the base and/or core slurries, foaming agent and other additives can be included. The foaming agent can be added by addition in the primary discharge conduit. In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. It has been found that suitable void distribution and wall thickness can be effective to enhance strength, especially in lesser density board (e.g., 35 pcf of less). See, e.g., U.S. Pat. Nos. 9,802,866 and 9,840,066. Evaporative water voids, generally having voids of 5 μm or less in diameter, also contribute to the total void distribution along with the aforementioned air (foam) voids.

Polyphosphate can optionally be included in the base slurry and/or core layer slurry, e.g., in order to enhance sag resistance in the board. Trimetaphosphate compounds can be used, including, for example, sodium trimetaphosphate, potassium trimetaphosphate, lithium trimetaphosphate, and ammonium trimetaphosphate. If included, the polyphosphate can be included in the core slurry in the same, or a greater, amount than in the dense layer slurry. Alternatively, if desired, the polyphosphate can be included in the dense layer slurry in a greater amount than the core slurry (e.g., via addition through the secondary discharge conduit).

With respect to the polyphosphate (e.g., sodium trimetaphosphate), the core slurry and/or base slurry can include it in any suitable amount, e.g., from 0.01% to 0.5% by weight of the stucco, from 0.01% to 0.4%, from 0.05% to 0.3%, from 0.1% to 0.5%, from 0.1% to 0.4%, from 0.1% to 0.3%, from 0.1% to 0.2%, from 0.15% to 0.5%, from 0.2% to 0.4%, from 0.3% to 0.5%, by weight of the stucco, etc.

In addition, the base and/or the core slurry can optionally include at least one dispersant to enhance fluidity in some embodiments. Like other ingredients, the dispersants may be included in a dry form with other dry ingredients and/or in a liquid form with other liquid ingredients in the core slurry. Examples of dispersants include naphthalenesulfonates, such as polynaphthalenesulfonic acid and its salts (polynaphthalenesulfonates) and derivatives, which are condensation products of naphthalenesulfonic acids and formaldehyde; as well as polycarboxylate dispersants, such as polycarboxylic ethers, for example, PCE211, PCE111, 1641, 164IF, or PCE 2641-Type Dispersants, e.g., MELFLUX 2641F, MELFLUX 2651F, MELFLUX 1641F, MELFLUX 2500L dispersants (BASF), and COATEX Ethacryl M, available from Coatex, Inc.; and/or lignosulfonates or sulfonated lignin.

The base and/or core slurry can include accelerator and/or retarder. Accelerator (e.g., wet gypsum accelerator, heat resistant accelerator (HRA), climate stabilized accelerator) and retarder are well known and can be included in the core slurry, if desired. See, e.g., U.S. Pat. Nos. 3,573,947 and 6,409,825. In some embodiments where accelerator and/or retarder are included, the accelerator and/or retarder each can be in the base and/or core slurry in an amount on a solid basis of, such as, from 0% to 10% by weight of the stucco (e.g., 0.1% to 10%), such as, for example, from 0% to 5% by weight of the stucco (e.g., 0.1% to 5%).

Other additives can be included (by addition in the base and/or core slurries) in a concentration in the core slurry that is the same or greater than the concentration in the dense layer slurry. Such additives include structural additives, including mineral wool, perlite, clay, calcium carbonate, and chemical additives, including fillers, sugar, enhancing agents (such as phosphonates, borates and the like), binders (such as latex), colorants, fungicides, biocides, hydrophobic agent (such as a silicone-based material, including a silane, siloxane, or silicone-resin matrix, e.g.), and the like. Examples of the use of some of these and other additives are described, for instance, in U.S. Pat. Nos. 7,244,304; 7,364,015; 7,803,226; 7,892,472; 6,342,284; 6,632,550; 6,800,131; 5,643,510; 5,714,001; and 6,774,146; and U.S. Patent Application Publication 2002/0045074. Other examples of such additives include fire-rated and/or water resistant product that can also optionally be included in the base and/or the core slurry, include e.g., siloxanes (water resistance); heat sink additives such as aluminum trihydrite (ATH), magnesium hydroxide or the like; and/or high expansion particles (e.g., expandable to 300% or more of original volume when heated for one hour at 1560° F.). See, e.g., U.S. Pat. No. 8,323,785 for description of these and other ingredients. In some embodiments, high expansion vermiculite is included, although other fire resistant materials can be included.

The weight ratio of water to calcined gypsum can be any suitable ratio, although, as one of ordinary skill in the art will appreciate, lesser ratios can be more efficient because less excess water will remain after the hydration process of the stucco is completed during manufacture, thereby conserving energy. In some embodiments, the cementitious slurry can be prepared by combining water and calcined gypsum in a suitable water to stucco weight ratio for board production depending on products, such as in a range between 0.6 and 1.2, e.g., 0.8. In embodiments, for any given board, the dense layer slurry may have a greater water/stucco ratio than the core slurry. For example, the core slurry formulations can be made with any suitable water/stucco ratio, e.g., 0.6 to 1.2, 0.6 to 1.1, 0.6 to 1, 0.6 to 0.9, 0.6 to 0.85, 0,6 to 0.8, 0,6 to 7.5, 0.6 to 0.7. 0.6 to 0,65, etc. The dense layer slurry formulations can be made with any suitable water/stucco ratio, e.g., 0,8 to 1.5, 0,8 to 1.4, 0,8 to 1.3, 0,8 to 1.2, 0,8 to 1.1., 0,8 to 1,0, 0.8 to 0.95, 0.8 to 0.9, 0.8 to 0.85, etc.

With respect to the cover sheets, they can be formed of any suitable material and basis weight. For example, some embodiments of the disclosure allow for good board strength even with the use of lower basis weight cover sheets such as, for example, less than 45 lb/MSF (e.g., 33 lb/MSF to 45 lb/MSF) even for lower weight board (e.g., having a density of 35 pcf or below). However, if desired, in some embodiments, heavier basis weights can be used, e.g., to further enhance nail pull resistance or to enhance handling, e.g., to facilitate desirable “feel” characteristics for end-users. In some embodiments, to enhance strength (e.g., nail pull strength), especially for lower density board, one or both of the cover sheets can be formed from paper and have a basis weight of, for example, at least 45 lb/MSF (e.g., from 45 lb/MSF to 65 lb/MSF, 45 lb/MSF to 60 lb/MSF, 45 lb/MSF to 55 lb/MSF, 50 lb/MSF to 65 lb/MSF, 50 lb/MSF to 60 lb/MSF, etc.). If desired, in some embodiments, one cover sheet (e.g., the “face” paper side when installed) can have aforementioned greater basis weight, e.g., to enhance nail pull resistance and handling, while the other cover sheet (e.g., the “back” sheet when the board is installed) can have somewhat lower weight basis if desired (e.g., weight basis of less than 45 lb/MSF, e.g., from 33 lb/MSF to 45 lb/MSF (e.g., 33 lb/MSF to 40 lb/MSF).

The board can be prepared in any suitable manner. In embodiments, a main mixer containing an agitator as understood in the art is used at a wet end of a manufacturing line as also understood in the art. The agitator can be in the form of pins, disk, impeller, propeller, rotor spinning inside a stationary housing, or the like. The main mixer can be used to prepare a base slurry for preparing a core and dense slurry, respectively. Stucco, water, and optionally, a base additive package are inserted into the main mixer. The mixer contains a primary discharge conduit and a secondary discharge conduit. Slurry is discharged from the primary discharge conduit where core additives such as foam (see, e.g., U.S. Pat. No. 5,683,635) are inserted to form a core slurry. Slurry is also discharged from the secondary discharge conduit where cellulosic fiber, and optionally, strength-enhancing starch and/or polyphosphate, is inserted into the base slurry to form a dense layer slurry.

The relative amounts of base slurry that are discharged through the primary and secondary discharge conduits, respectively, can be selected to form the core layer and dense layer of desired dimensions. In embodiments, a majority (i.e., greater than 50%) of the base slurry is discharged through the primary discharge conduit since the core layer generally has greater thickness than the dense layer. In some embodiments, at least 60% of the base slurry is discharged through the primary discharge conduit (e.g., at least 70%, at least 80%, at least 90%, at least 95%, such as from 50% to 99%, from 50% to 95%, from 50% to 90%, from 60% to 99%, from 60% to 95%, from 60% to 90%, from 60% to 85%, from 60% to 80%, from 70% to 99%, from 70% to 95%, from 70% to 90%, from 70% to 85%, from 70% to 80%, from 80% to 99%, from 80% to 95%, or from 80% to 90%, etc.).

In embodiments, the cellulosic fiber inserted into the secondary discharge conduit includes paper fiber. Prior to addition to the secondary discharge conduit, the paper fiber is put into a water suspension. The suspension can have any suitable amount of paper fiber, such as from 1% to 7% fiber, from 1% to 6% fiber, from 1% to 5% fiber, from 1% to 4% fiber, from 1% to 3% fiber, from 2% to 7% fiber, from 2% to 6% fiber, from 2% to 5% fiber, from 2% to 4% fiber, from 3% to 7% fiber, from 3% to 6% fiber, from 3% to 5% fiber, or from 3% to 4% fiber, etc.). The pulp suspension is subjected to non-laminar (e.g., turbulent) flow prior to insertion into the secondary discharge conduit.

In some embodiments, the cellulosic fiber is generally delivered while in water. The cellulosic forms a suspension of pulp in the water. The cellulosic fiber suspension is desirably in a non-laminar (e.g., turbulent) state when it is inserted into the slurry for forming the dense layer. In this regard, the pulp suspension is delivered in a sufficiently turbulent manner to avoid agglomeration of the cellulosic fiber and the formation of flocs (e.g., having a length of at least 3 mm) in appreciable amounts. Flocs generally have fiber length of greater than 3 mm, such as from 3 mm to 8 mm, or from 3 mm to 5 mm. In this regard, it is desired to have 10% or less of the fibers in the form of such flocs so that the fiber suspension can be properly mixed into the dense layer slurry to allow for enhanced strength enhancement. In embodiments, 7% or less of the fibers form flocs, such as 5% or less, 3% or less, or 1% (e.g., from 1% to 10%, from 1% to 7%, from 1% to 5%, from 1% to 3%, from 3% to 10%, from 3% to 7%, from 3% to 5%, from 5% to 10%, from 5% to 8%, or from 7% to 10%, etc.) or less.

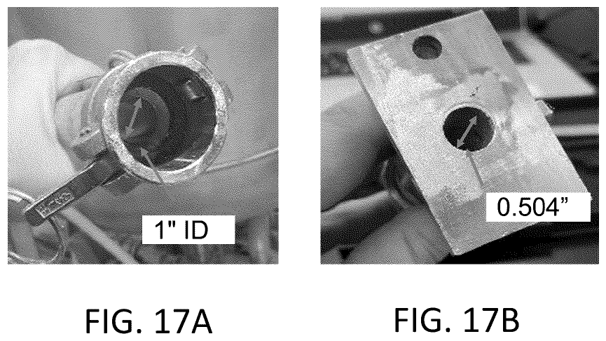

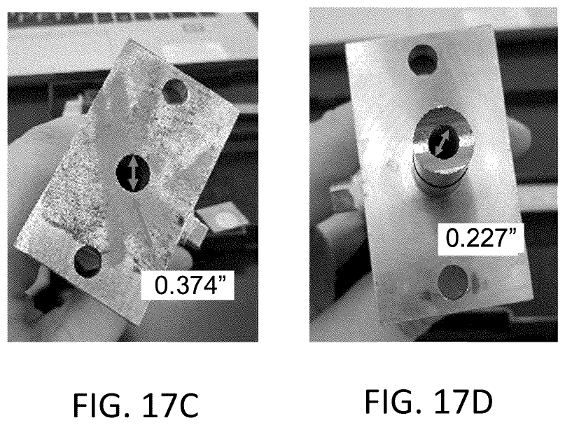

The paper cellulosic suspension can be prepared and inserted into the slurry for forming the dense layer in any suitable manner. To illustrate, in embodiments, cellulosic fiber and water can be added and mixed in a tank containing an agitator to mix and maintain the contents therein as a suspension. The suspension is delivered to the secondary discharge conduit, e.g., via a passageway such as a pipe, tube, hose, duct, which terms may be used interchangeably, etc., with constricted inner diameter to promote forming the desired non-laminar (e.g., turbulent) state. To illustrate, FIGS. 17A-D depict exemplary inner diameters ranging from 0.227″* to 1″. FIG. 17A shows an inner diameter of 1″; FIG. 17B shows an inner diameter of 0.504″; FIG. 17C shows an inner diameter of 0.374″; FIG. 17D shows an inner diameter of 0.227″. The size of the inner diameter will vary depending on particular conditions including, fiber dimensions and the amount of fiber in the suspension. In some embodiments, the inner diameter of the hose is less than 0.625 inch (such as less than 0.5 inch or less than 0,375 inch, e.g., from 0.125 inch to 0,625 inch, from 0.125 inch to 0.5 inch, from 0,125 inch to 0.375 inch, from 0.125 inch to 0.225 inch, from 0.225 inch to 0.375 inch, from 0.25 inch to 0.625 inch, from 0.25 inch to 0.5 inch, from 0.25 inch to 0.375 inch, from 0.375 inch to 0.625 inch, or from 0.375 inch to 0.5 inch, etc.). The suspension desirably is maintained under the non-laminar, such as turbulent, condition upon entry into the secondary discharge conduit prior to being added to the slurry for forming the dense layer.

Cellulosic fibers have a large aspect ratio (measured by length to the diameter), e.g., from 40:1 to 100:1, and results in significant contact among fibers in a pulp suspension. This contact can have a tendency to lead to undesirable formation of flocs. The present inventors have discovered that, surprisingly and unexpectedly, by avoiding formation of these flocs by the delivery of the fiber suspension in a non-laminar (e.g., turbulent) state, the fiber can be mixed properly and added effectively and homogenously to the slurry for forming the dense layer. In this manner, surprisingly and unexpectedly, the present inventors have discovered that plug flow can be avoided, by disrupting flocs by way of shear stress from non-laminar (e.g., turbulent) flow. In this regard, plug flow is undesirable and occurs when the pulp fibers interact with each other to form flocs and undesirably flow as a rigid body. This would otherwise result in a pulp suspension that is not homogeneous (i.e a fiber concentrated floc phase and water phase).

Increased shear force from the turbulent flow is believed to disperse individual fibers in the water. Thus, in embodiments, the pulp suspension is in a turbulent flow so that the pulp fiber can be homogeneously transported and individual fibers can be dispersed in the dense layer gypsum slurry, instead of undesirably having flocs.

In some embodiments, the desired turbulent state is formed when the cellulosic fiber suspension is subjected to a flow velocity greater than the onset velocity of turbulence of the cellulosic fiber suspension. The onset velocity of turbulence can be determined according to a rheology test or a pulp head friction test. The rheology test is set forth in Ventura, C., “Modeling Pulp Fiber Suspension Rheology,” TAPPI Journal, pages 20-26 (2008)). The pulp head friction test is set forth in Ventura, C., ° Flow Dynamics of Pulp Fiber Suspensions,” TAPPI Journal, Vol. 6, No. 7, pages 17-23 (2007)).

The fibers can be included in any suitable amount to water to form the suspension. By way of illustration, and not limitation, in one embodiment, cellulosic fiber is added in water in an amount to form a pulp suspension containing 3% cellulosic fiber. The pulp suspension is held in a holding tank equipped with an agitator and then pumped through a hose. In embodiments, the pulp suspension is added to the slurry for forming the dense layer at a flow velocity above the onset velocity of turbulence for that specific pulp suspension. The onset velocity of turbulence of the 3% pulp suspension according to the pipe head friction loss test as described herein was found to be 3 m/s. The diameter of the hose is selected to ensure that the pulp flows above 3 m/s and, thus, in a turbulent state. For this design, at a flow rate of 40.5 lb/min, a hose having a 0.375 inch inner diameter produces a flow velocity of 3.2 m/s such that the pulp is in a turbulent state. Using this procedure, turbulence can be achieved at a given amount of fiber in a pulp suspension.

As an alternative test, Reynolds number (Re) can be used to identify laminar and turbulent flows. The value of Reynolds number (Re) can be expressed as Re=pVD/u, wherein/) is the density of the fluid, Vis the fluid velocity, D is the hydraulic diameter (of a passageway such as a pipe, tube, hose, duct, etc.), and u is the fluid viscosity. The viscosity is measured using a rheometer with a shear rate ramp. Viscosity is defined at the velocity of the pulp in the hose. A flow is considered laminar if the Reynolds number is up to 2300. Thus, in some embodiments, the desired non-laminar flow can be expressed as having a Reynolds number greater than 2300. A flow is considered turbulent if the Reynolds number is greater than 3500 wherein a faster and irregular flow path maximizes the inertial force in the system. In some embodiments, the turbulent flow can be expressed as having a Reynolds number greater than 3500. In embodiments, the pipe head friction test is preferred as a technique to determine laminar versus turbulent flow. It is to be noted that it is not necessary that the type of flow be determined using the Reynolds number, nor is it necessary that laminar versus turbulent flow be determined by more than one of the alternate methods.

While both of the dense layer slurry and core slurry contain the ingredients included in the base slurry, separate additions into the primary discharge conduit and the secondary discharge conduit allow for individually tailoring of the formulations of the respective dense and core slurries. In this regard, the dense layer slurry contains the cellulosic fiber (e.g., paper fiber) and, optionally, the strength-enhancing starch in greater quantities than the core slurry.

In embodiments, the core slurry contains additives (e.g., accelerator, retarder, polyphosphate, dispersant, migrating starch, etc.) in amounts greater than or the same as the amounts by weight in the dense layer slurry. In this regard, some or all of these ingredients can optionally be inserted directly into the core slurry via the primary discharge conduit, in which case such additives would be present in a greater concentration in the core slurry than in the dense layer slurry. One or more of these additives could be inserted into the main mixer and hence would be present in the base slurry. Addition in this manner would lead to a similar concentration in the dense layer and the core layer. Surprisingly and unexpectedly, by selectively targeting particular ingredients into the dense and core slurries in this manner, board can be prepared at a low board weight and density, while maintaining good board strength (e.g., via nail pull resistance) in an efficient manner.

A first moving cover sheet (e.g., over a moving conveyor) is provided. The board is generally formed upside down at the wet end of the plant such that the first moving cover sheet is generally the face cover sheet, although this is not mandatory. The dense layer slurry is deposited over the moving cover sheet. The core slurry is deposited over the dense layer. A second moving cover sheet (e.g., the back paper) is applied over the core slurry layer to form a sandwich structure of a board precursor. In embodiments, the dense layer slurry is deposited onto the moving cover sheet upstream of the mixer, while the core slurry is deposited over the cover sheet bearing the dense layer, downstream of the mixer. In some embodiments, the secondary discharge conduit is disposed on the mixer upstream of the primary discharge conduit to conveniently accommodate this arrangement of depositing the layers relative to the positioning of the mixer.

If desired, it will be understood that the board can be prepared using two separate mixers equipped with agitators, with one mixer dedicated for preparing the core slurry and the other mixer dedicated for preparing the core slurry. As such, each of the dense layer and core slurries can be separately formulated (without the need for a base slurry) and discharged out of each mixer and then applied to form the board as described herein.

After the sandwich structure of the board precursor is formed at the wet end of the manufacturing line, the board precursor sets as it travels, e.g., by conveyor, to other stations, including a knife, where the board precursor is cut into segments. The board can then be flipped and dried in a kiln to form the final board product and processed at the dry end of the manufacturing line, e.g., to a final size, as understood by one of ordinary skill in the art.

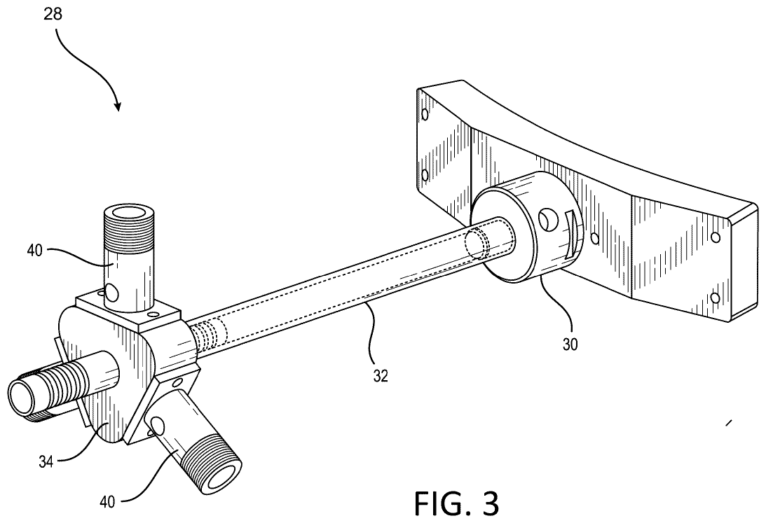

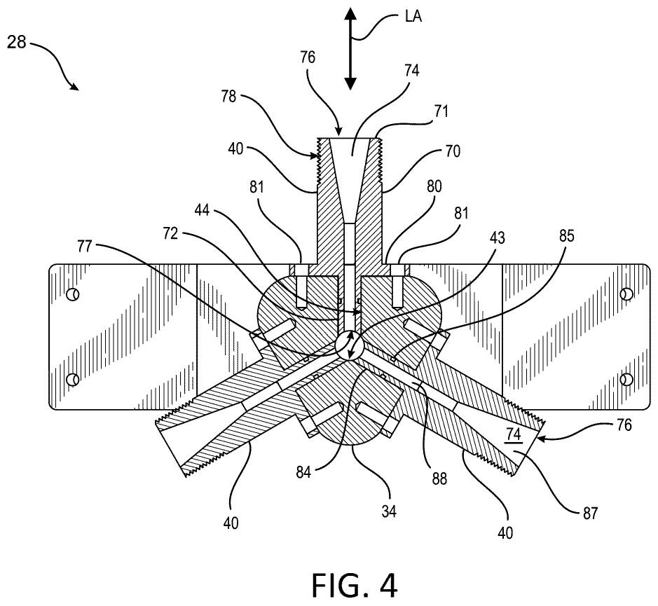

An embodiment of an additive injection system 28 constructed according to principles of the present disclosure is shown in FIGS. 3 and 4. The additive injection system 28 is suitable for use in embodiments of a slurry mixing and dispensing assembly following principles of the present disclosure. In embodiments, the additive injection system 28 can be configured to introduce at least one additive into a secondary stream of cementitious slurry dispensed from a mixer into a secondary discharge conduit 21 such that the secondary stream of cementitious slurry is different from a core stream of cementitious slurry being dispensed from a main discharge conduit.

Referring to FIG. 3, in the illustrated embodiment, the additive injection system 28 comprises a mixer extractor configured for use in extracting and conveying a secondary slurry from the mixer, The additive injection system 28 includes an extractor 30, a secondary conduit section 32, an injection body 34, and a plurality of injection port members 40 attached to the injection body 34.

The extractor 30 can be any suitable extractor configured to facilitate the discharge of a secondary slurry stream from a mixer. In embodiments, the extractor 30 can be a commercially-available extractor which is compatible for use with the mixer with which it is intended to be used, as will be appreciated by one skilled in the art.

The conduit section 32 extends between the extractor 30 and the injection body 34. The conduit section 32 can comprise a portion of a secondary discharge conduit. In embodiments, a similar conduit section is installed downstream of the injection body 34 and is of sufficient length to deliver the secondary slurry to an appropriate discharge point along the manufacturing line.

In embodiments, the conduit 32 is made from any suitable resiliently flexible material, such as a suitable elastomeric material (Tygon® tubing or the like, e.g.), and is of sufficient strength and flexibility that, upon being subjected to radial compressive pressure, is capable of being reduced in size (e.g., to approximately one-half the original diameter). In embodiments, any conduit tubing exhibiting elastic properties can be used. Preferably, the conduit 32 has a cross-sectional diameter in a range between one inch and four inches and has a wall thickness of approximately ¾-inch. However, in other embodiments, other cross-sectional diameters and wall thicknesses can be used to suit the intended application. Exemplary factors which can influence the particular thickness and configuration of the conduit 32 employed include, among other things, the thickness of the wallboard being produced, the amount of slurry required, the distance between the mixer and the discharge point for the secondary slurry, and the particular characteristics of the slurry formulation, including the setting rate, the water/stucco ratio, fiber usage, and the percentage of any other additive desired.

In embodiments, the injection body 34 can comprise a portion of a secondary discharge conduit which is in fluid communication with a mixer adapted to produce a main core stream and at least one secondary stream of cementitious slurry. The injection body 34 can be made from any suitable material, such as a suitable metal or any other suitable material which can be used to convey cementitious slurry therethrough during the manufacture of a cementitious product, using any suitable technique. In embodiments, the injection body 34 can be made from a suitable metal, such as, aluminum, stainless steel, brass, etc. In embodiments, at least a portion of the injection body 34 can be plated with a suitable material (e.g., chrome) to increase its durability.

Referring to FIGS. 3 and 4, the injection port members 40 can be removably mounted to the injection body 34 via suitable threaded fasteners. The injection body 34 is compatible with different types of injection port members having a similar footprint and exterior mounting structure but with different interior passageways for the additive(s) to be conveyed therethrough. The injection port members 40 and the injection body 34 shown in FIG. 4 comprise an embodiment of an additive injection system 28 constructed in accordance with principles of the present disclosure. In embodiments, a suitable number of the injection port members 40 can be associated with the injection body 34. The different types of injection port members can be interchangeably used with the injection body 34 to inject one or more additives (such as, aqueous fiber, e.g.) into a flow of cementitious slurry passing through the injection body 34 under different flow conditions. In use, a set of injection port members including at least one different type of injection port member from the other injection port members in the set can be removably mounted to the injection body 34 at a given time.

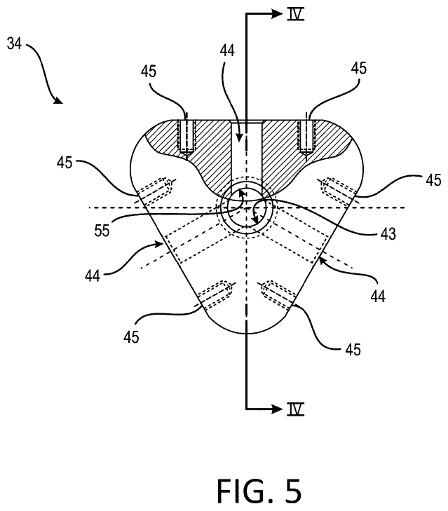

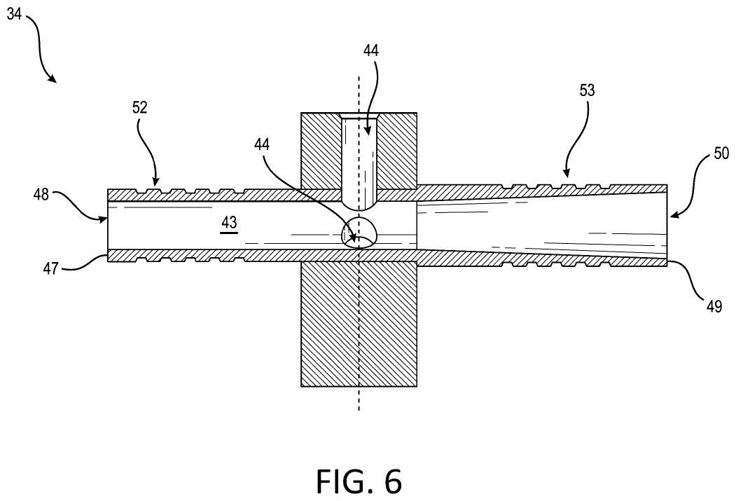

Referring to FIGS. 5 and 6, in embodiments, the injection body 34 defines a slurry passageway 43 and at least one port passageway 44 in fluid communication with the slurry passageway 43. In embodiments, the injection body 34 defines at least two port passageways 44 in fluid communication with the slurry passageway 43.

Referring to FIG. 5, in the illustrated embodiment, the injection body 34 defines three port passageways 44 in fluid communication with the slurry passageway 43. In embodiments, the additive injection system 301 can include at least two sets of different types of injection port members, each corresponding to the number of port passageways 44 in the injection body 34. The injection body 34 defines a plurality of tapped fastener bores 45 configured to threadingly receive therein a fastener for mounting a suitable injection port member to the injection body 34 such that the injection port member is associated with one of the port passageways 44.

Referring to FIG. 6, in embodiments, the slurry passageway 43 of the injection body 34 is adapted to receive a flow of cementitious slurry and convey it to a downstream part of the manufacturing system. The illustrated injection body 34 comprises a part of a secondary discharge conduit and includes a slurry inlet end 47 defining a slurry inlet opening 48 and a slurry discharge end 49 defining a slurry discharge opening 50. The slurry passageway 43 is in fluid communication with the slurry inlet opening 48 and the slurry discharge opening 50. In embodiments, the slurry inlet end 47 and the slurry discharge end 49 can be adapted to be secured to an upstream portion and a downstream portion, respectively, of a cementitious mixing and dispensing assembly.

The illustrated slurry inlet end 47 and the slurry discharge end 49 of the injection body 34 each has an external barbed surface 52, 53 which is configured to promote a friction fit between the external barbed surface 52, 53 and an internal surface of a suitably-sized secondary discharge conduit. An adjustable hose clamp can be fitted to the exterior surface of the discharge conduit, placed in overlapping relationship with the portion of the injection body 34 disposed within the slurry conduit, and tightened to further promote the retentive engagement of the discharge conduit to the injection body 34.

In embodiments, the slurry inlet end 47 of the injection body 34 can be adapted to be placed in fluid communication with a slurry mixer and to receive a secondary flow of slurry therefrom. One or more additives, such as aqueous fiber, for example, can be injected into the secondary flow of slurry inside the slurry passage 43 via one or more injection port members which are removably mounted to the injection body 34 to form a dense slurry. The dense slurry can be discharged from the injection body 34 out the slurry discharge end 49. In embodiments, the slurry discharge end 49 of the injection body 34 can be arranged with a delivery conduit of the secondary discharge conduit which is adapted to convey the dense slurry to a discharge point for application to one of the cover sheets. In the illustrated embodiment, the slurry discharge opening 50 is larger than the slurry inlet opening 48 to account for the introduction of the additive(s) via the injection port member(s).

Referring to FIG. 5, each of the illustrated port passageways 44 has a similar construction. Accordingly, it should be understood that the description of one port passageway 44 is equally applicable to each of the other port passageways 44, as well. Each port passageway 44 has a port opening 55 in fluid communication with the slurry passageway 43. Each port passageway 44 is disposed in substantially perpendicular relationship to a direction of slurry flow through the slurry passage 43, In other embodiments, at least one port passageway 44 can have a different orientation with respect to the slurry passage 43 along at least one plane relative to the direction of slurry flow through the slurry passageway 43.

The illustrated port passageways 44 are substantially evenly spaced with respect to each other about the circumference of the slurry passageway 43 so that they are one hundred twenty degrees apart from each other. In other embodiments, the injection body 34 can define different relative spacing between the port passageways 44.

Referring to FIG. 4, each of the illustrated injection port members 40 has a similar construction. Accordingly, it should be understood that the description of one injection port member 40 is equally applicable to each of the other injection port members 40, as well. In embodiments, the injection port members 40 are suitable for use in embodiments of an additive injection system 28 following principles of the present disclosure. The injection port members 40 can be adapted to receive a flow of at least one additive, such as aqueous fiber from a fiber supply conduit in fluid communication with a supply of aqueous fiber, such as from a tank of aqueous fiber, for example, and inject the additive(s) into a cementitious slurry passing through the slurry passageway 43 of the compatible injection body 34 of the additive injection system 28 to which the injection port members 40 are removably mounted.

Each injection port member 40 can be made from any suitable material, such as a suitable metal or any other suitable material which can be used to convey an additive therethrough at a pressure suitable for injecting the additive(s) into cementitious slurry during the manufacture of a cementitious product, using any suitable technique. In embodiments, the injection port member 40 can be made from a suitable metal, such as, aluminum, stainless steel, brass, etc. In embodiments, at least a portion of the injection port member 40 can be plated with a suitable material (e.g., chrome) to increase its durability.

Referring to FIG. 4, each injection port member 40 includes a port insert body 70 extending along a longitudinal axis LA between an additive supply end 71 and a mounting end 72. The port insert body 70 is generally in the form of a hollow cylinder such that the injection port member 40 defines an additive passageway 74 therethrough. The additive supply end 71 defines an additive inlet opening 76, and the mounting end 72 defines an additive outlet opening 77 (see FIG. 6 also). The additive passageway 74 extends between, and is in fluid communication with, the additive inlet opening 76 and the additive outlet opening 77.

The injection port member 40 is adapted to removably mount to a mating injection body 34 such that the additive passageway 74 is in fluid communication with the slurry passageway 43 of the injection body 34 through a port passageway 44 defined in the injection body 34 and in fluid communication with the slurry passageway. The injection port member 40 is adapted to receive a flow of additive(s) entering the additive inlet opening 76 and inject the flow of additive(s) into a flow of cementitious slurry passing through the slurry passage 43 of the injection body 34 to which the injection port member 40 is removably mounted by discharging the flow of additive(s) out of the additive outlet opening 77.

The supply end 71 is adapted for retentive engagement with a suitable additive(s) supply conduit. The illustrated supply end 71 includes an external threaded surface 78 which is adapted to sealingly engage a mating internal threaded surface of a suitable coupling of an additive(s) supply conduit.

In other embodiments, the supply end 71 can include another suitable mounting structure for retentive coupling with an additive(s) supply conduit. For example, in other embodiments, the supply end 71 can include an external barbed surface which can promote a friction fit between the external barbed surface and an internal surface of a suitably-sized supply conduit. An adjustable hose clamp can be fitted to the exterior surface of the additive(s) supply conduit, placed in overlapping relationship with the portion of the supply end 71 disposed within the additive(s) supply conduit, and tightened to further promote the retentive engagement of the additive(s) supply conduit to the supply end 71 of the injection port member 40.

In embodiments, the mounting end 72 of the injection port member 40 can include structure suitable for removably mounting the injection port member 40 to a mating injection body 34. In embodiments, at least a portion of the mounting end 72 of the injection port member 40 can be disposed in a port passageway 44 of the injection body 34 when the injection port member 40 is removably mounted thereto, as shown, e.g., in FIG. 4.

The illustrated injection port member 40 includes a mounting flange 80 extending radially outwardly from the port insert body 70. The mounting flange 80 defines a pair of mounting holes 81, which are each configured to receive a fastener therethrough. In embodiments, the mounting flange 80 can define only one mounting hole 81 or more than two mounting holes 81. Each mounting hole 81 of the mounting flange 80 can be adapted to align with a mating mounting hole 45 defined in the compatible injection body 34 so that one or more fasteners can be used to removably mount the injection port member 40 to the compatible injection body 34.

Referring to FIG. 4, each injection port member 40 is configured to removably mount to the injection body 34 such that the mounting end 72 of the injection port member 40 is disposed within a port passageway 44 defined in the injection body 34. The mounting end 72 of the illustrated injection port member 40 includes a distal portion 84 having a reduced exterior diameter. An elastomeric o-ring 85 can be fitted around the distal portion 84 for sealing engagement with the port passageway 44 of the injection body 34.

In embodiments, the injection port member can be secured using other techniques. For example, in embodiments, the mounting end 72 of the injection port member 40 can include a threaded surface adapted to retentively engage a mating threaded surface of the injection body 34, which can be associated with the port passageway 44. In embodiments, the mating threaded surface of the injection body 34 can be an internal threaded surface in each port passageway 44 of the injection body 34.

To facilitate the compatibility of different types of injection port members with the same additive(s) supply conduit and the same mating injection body 34, the additive passageway 74 can include a tapered entry portion 87 and a main portion 88. The tapered entry portion 87 can include the inlet opening 76. The entry portion 87 can provide a variable transition area in which the flow of additive(s) moves from the supply conduit with a particular cross-sectional area to the main portion 88 of the additive passageway 74, which includes an orifice with an orifice size that is different from the size of the supply conduit. In embodiments, the entry portion 87 can be configured to facilitate the transition of the flow of additive(s) from the supply conduit to the injection port member 40 to help promote the injection of the additive(s) into the secondary stream.

The illustrated entry portion 87 is generally frusto-conical in longitudinal cross-section. In other embodiments, the entry portion 87 can have a different shape adapted to transition the flow of additive(s) from the supply conduit with a supply outlet opening having a particular cross-sectional area to the main portion 88 of the additive passageway 74. The illustrated additive inlet opening 76 has a size that is larger than the orifice size of the outlet opening 77. The illustrated main portion 88 has a cross-sectional size corresponding to the orifice size of the outlet opening 77. The illustrated main portion 88 has a substantially uniform cross-sectional area along its length over the longitudinal axis LA.

In embodiments, the geometry of the slurry passage 43 within the injection body 34 is not compromised or disrupted when the different types of injection port members are mounted to the injection body 34. In embodiments, the injection port member does not project into the slurry passage 43 when it is fully mounted to the injection body 34 so that the flow of cementitious slurry through the slurry passage 43 is not disrupted by a structural feature of the injection port member.

In embodiments, the injection port member 40 can be adapted to include a flush-mounting feature wherein the mounting end 72 is substantially flush with the interior geometry of the slurry passageway 43 of a compatible injection body 34. In the illustrated embodiment, the mounting end 72 of the injection port member 40 has a distal end face with a concave portion with a radius of curvature that matches that of the slurry passageway 43 to define a substantially flush interface therebetween.

In embodiments, different types of injection port members can have differently-shaped additive passageways 74. In embodiments, the additive passageway 74 can have a configuration adapted to promote a fluid flow characteristic. In embodiments, each one of the different types of injection port members is adapted to be removably mounted to any one of the port passageways 44 of the injection body 34.

Each type of injection port members is adapted to removably mount to the injection body 34 such that the respective additive passageway 74 is in fluid communication with the slurry passageway 43 via the port passageway 44 with which the injection port member is associated. In the illustrated embodiment, each port passageway 44 is configured to receive the mounting end 72 of either of at least two types of injection port member therein.

In embodiments, each type of injection port member is adapted to removably mount to the injection body 34 in the same way as the first type of injection port member 40 such that its respective additive passageway is in fluid communication with the slurry passageway 43 via the port passageway 44 with which it is associated, In embodiments of an additive injection system according to principles of the present disclosure, first and second types of injection port members can be provided which are similar in construction, including mounting structure, but with different orifice sizes and/or additive passageway features. Each type of injection port member can be removably mounted to the same compatible injection body 34 so that the respective additive passageway is in fluid communication with the slurry passageway 43 of the injection body 34 via the port passageway 44. The particular injection port member 40 mounted to the injection body 34 can be removed and replaced with the other type of injection port member to modify the flow of additive(s) into the slurry passage 43 of the mating injection body 34, such as to vary the injection pressure into the flow of cementitious slurry passing through the slurry passageway 43 of the injection body 34.

In embodiments, an additive injection system according to principles of the present disclosure can include more than two types of injection port members each with an additive passageway having a different shape and/or size configured to produce at least one variable flow characteristic through the use of the different types of injection port members. In embodiments, an additive injection system according to principles of the present disclosure can include a set of different types of injection port members which have additive passageways with different orifice sizes of a variable inner diameter over a predetermined range, such as a set of different types of injection port members having a variable orifice size between an inner diameter of ¼ of an inch and one inch, for example. In embodiments, the set of different types of injection port members can be incrementally sized over the range of orifice sizes, such as a set of different types of injection port members which have orifice sizes with an inner diameter increasingly sized from ¼ of an inch to one inch by an increment of 1/16 of an inch (i.e., ¼ of an inch, 5/16 of an inch, ⅜ of an inch, 7/16 of an inch, ½ of an inch. 9/16 of an inch, ⅝ of an inch, 11/16 of an inch, ¾ of an inch, 13/16 of an inch, ⅞ of an inch, 15/16 of an inch, and 1 inch). In other embodiments, different increments and/or ranges of orifice sizes can be used (including metric sets).

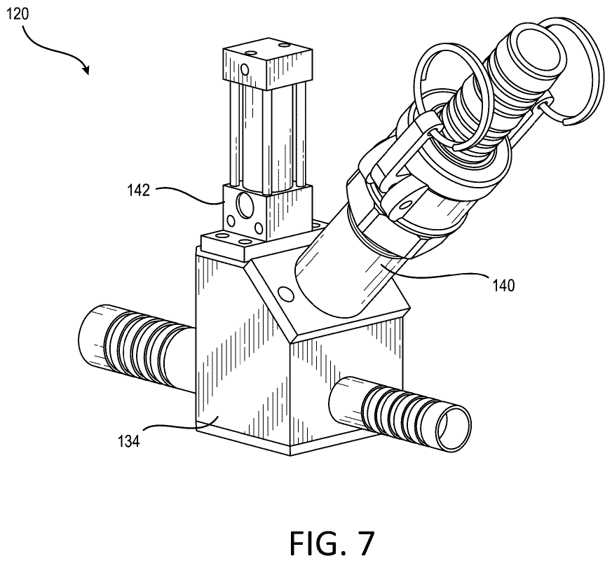

Referring to FIGS. 7-9, another embodiment of an additive injection system 120 constructed according to principles of the present disclosure is shown. The additive injection system 120 is suitable for use in embodiments of a slurry mixing and dispensing assembly following principles of the present disclosure, In embodiments, the additive injection system 120 can be configured to introduce at least one additive into a secondary stream of cementitious slurry dispensed from a mixer into a secondary discharge conduit such that the secondary stream of cementitious slurry is different from a core stream of cementitious slurry being dispensed from a main discharge conduit of the mixer.

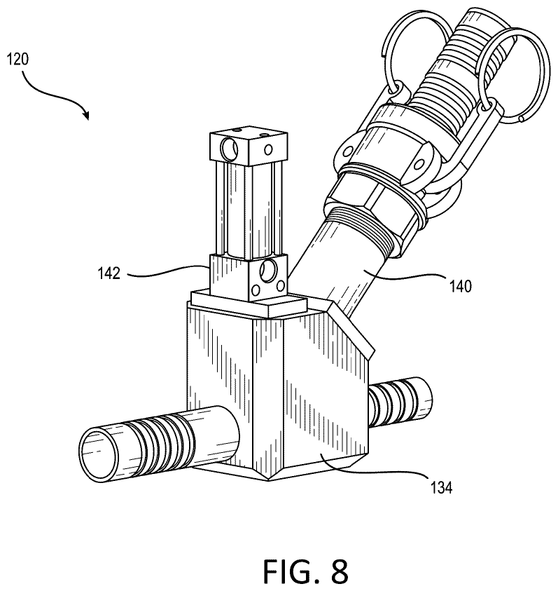

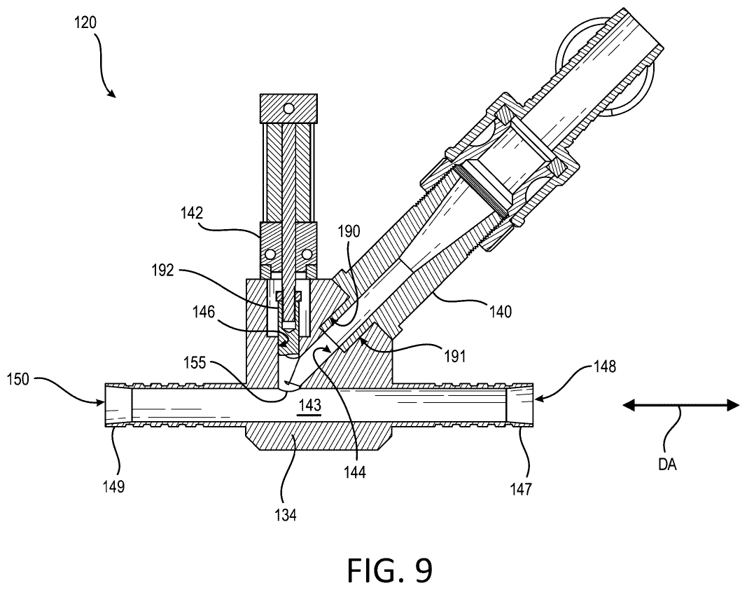

Referring to FIGS. 7 and 8, in the illustrated embodiment, the additive injection system 120 includes an injection body 134, an injection port member 140 removably attached to the injection body 134, and a valve 142 mounted to the body 134. Referring to FIG. 9, in embodiments, the injection body 134 can comprise a portion of a secondary discharge conduit which is in fluid communication with a mixer adapted to produce a main core stream and at least one secondary stream of cementitious slurry. The injection body 134 defines a slurry passageway 143, a port passageway 144 in fluid communication with the slurry passageway 143, and a valve passageway 146 in communication with the port passageway 144.

The slurry passageway 143 of the injection body 134 is adapted to receive a flow of cementitious slurry and convey it to a downstream part of the manufacturing system. The illustrated injection body 134 comprises a part of a secondary discharge conduit and includes a slurry inlet end 147 defining a slurry inlet opening 148 and a slurry discharge end 149 defining a slurry discharge opening 150. The slurry passageway 143 is in fluid communication with the slurry inlet opening 148 and the slurry discharge opening 150. In embodiments, the slurry inlet end 147 and the slurry discharge end 149 can be adapted to be secured to an upstream portion and a downstream portion, respectively, of a cementitious mixing and dispensing assembly.

The port passageway 144 is configured to be associated with one of a plurality of different types of injection port members 140 for receiving a flow of additive(s) in the slurry passageway 143 via the injection port member 140 mounted to the body 134. The port passageway 144 can include an internal threaded surface 190 for threadingly mating with an external threaded surface 191 of the injection port member 140. The port passageway 144 is disposed at a nominal forty-five degree port angle to a discharge axis DA defined by the slurry passageway 143. In embodiments, the port angle can be in a range between fifteen degrees and seventy-five degrees. The injection port member 140 is adapted to removably mount to the mating injection body 34 such that the additive passageway 174 is in fluid communication with the slurry passageway 143 of the injection body 134 through the port passageway 144 defined in the injection body 134 and in fluid communication with the slurry passageway 43.

The valve passageway 146 is configured to receive the valve 142 therein. In embodiments, the valve 142 is configured to selectively occlude the port opening 155 of the port passageway 144. In embodiments, the valve 142 can be controlled to occlude the port opening 155 of the port passageway 144 when no additive is being injected through the injection port member 140 mounted to the body 134.

In embodiments, any suitable valve 142 can be used to occlude the port opening 155. In the illustrated embodiment, the valve 142 comprises a pneumatic valve which can be arranged with a suitable air supply that is controlled to reciprocally move a piston 192 between an open position (as shown in FIG. 9) in which a flow of additive(s) can be injected into the slurry passage 143 via the injection port member 140 and a closed position in which the port opening is occluded by the piston 192. The additive injection system 120 can be similar in other respects to the additive injection system 20 of FIG. 3 as will be appreciated by one skilled in the art.

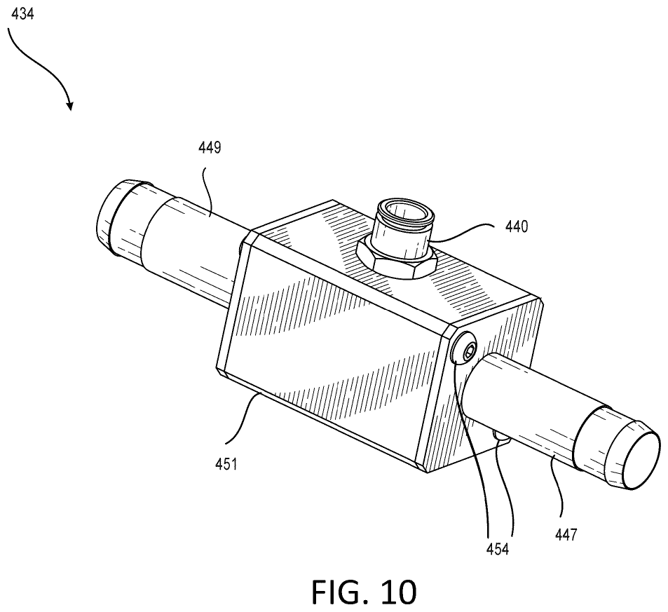

Referring to FIGS. 10-14, another embodiment of an injection body 434 is shown which is suitable for use in an additive injection system constructed according to principles of the present disclosure. The injection body 434 is suitable for use in embodiments of a slurry mixing and dispensing assembly following principles of the present disclosure. In embodiments, the injection body 434 can be configured to introduce at least one additive into a secondary stream of cementitious slurry dispensed from a mixer into a secondary discharge conduit such that the secondary stream of cementitious slurry is different from a core stream of cementitious slurry being dispensed from a main discharge conduit of the mixer.

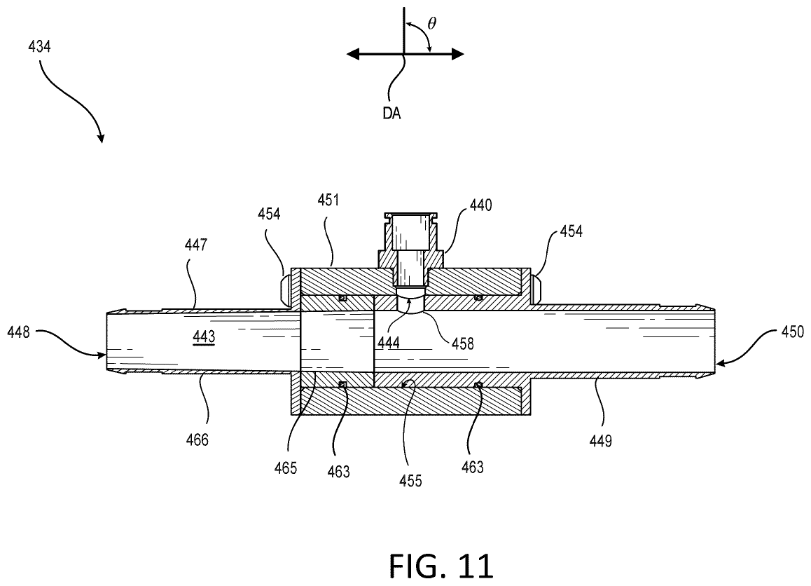

Referring to FIGS. 10 and 11, in embodiments, the injection body 434 can comprise a portion of a secondary discharge conduit which is in fluid communication with a mixer adapted to produce a main core stream and at least one secondary stream of cementitious slurry. In the illustrated embodiment, the injection body 434 includes an injection port member 440, a slurry inlet member 447, a slurry discharge member 449, and an injection block 451. The injection port member 440 is removably attached to the injection block 451 via a threaded connection. The slurry inlet member 447 and the slurry discharge member 449 are removably connected to opposing ends of the injection block 451 via threaded fasteners 454.

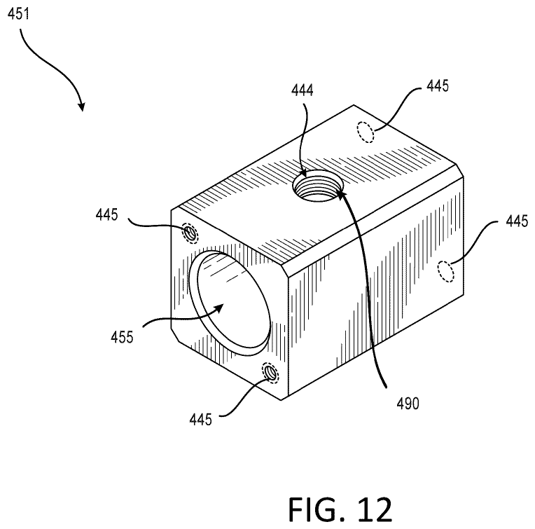

Referring to FIG. 11, the components of the injection body 434 are hollow such that they define internal passageways which cooperate together to define a slurry passageway 443 and a port passageway 444. The slurry inlet member 447 and the slurry discharge member 449 are in abutting relationship to each other and define the slurry passageway 443 which extends through a longitudinal through bore 455 defined in the injection block 451 (see also, FIG. 12). The injection block 451 defines the port passageway 444 which is in fluid communication with the slurry passageway 443 via a cross-bore opening 458 defined in the slurry discharge member 449 (see also, FIG. 14). In embodiments, the injection block 451 can define more than one port passageway 444, each of which being in fluid communication with the slurry passageway 443.

Referring to FIG. 11, in embodiments, the slurry passageway 443 of the injection body 434 is adapted to receive a flow of cementitious slurry and convey it to a downstream part of the manufacturing system. The illustrated injection body 434 comprises a part of a secondary discharge conduit and includes a slurry inlet member 447 defining a slurry inlet opening 448 and a slurry discharge member 449 defining a slurry discharge outlet opening 450. The slurry passageway 443 is in fluid communication with the slurry inlet opening 448 and the slurry discharge outlet opening 450. In embodiments, the slurry inlet member 447 and the slurry discharge member 449 can be adapted to be secured to an upstream portion and a downstream portion, respectively, of a cementitious mixing and dispensing assembly.

In embodiments, the slurry inlet member 447 of the injection body 434 can be adapted to be placed in fluid communication with a slurry mixer and to receive a secondary flow of slurry therefrom. One or more additives, such as aqueous fiber, for example, can be injected into the secondary flow of slurry inside the slurry passageway 443 to form a dense slurry via one of a selected set of injection port members 440 which is removably mounted to the injection block 451 such that it is in fluid communication with the port passageway 444. The dense slurry can be discharged from the injection body 434 out of the slurry discharge outlet opening 450 of the slurry discharge member 449. In embodiments, the slurry discharge member 449 of the injection body 434 can be arranged with a delivery conduit of the secondary discharge conduit which is adapted to convey the dense slurry to a discharge point for application to one of the cover sheets. In the illustrated embodiment, the cross-sectional area of the slurry discharge outlet opening 450 is larger than the cross-sectional area of the slurry inlet opening 448 to account for the introduction of the additive(s) via the injection port member(s).

The injection port member 440 is adapted to removably mount to the injection block 451 such that the additive passageway is in fluid communication with the slurry passageway 443 of the injection body 434 through the port passageway 444 defined in the injection block 451 and in fluid communication with the slurry passageway 443. In embodiments, the port passageway 444 is configured to be associated with one of a plurality of different types of injection port members 440 for receiving a flow of additive(s) in the slurry passageway 443 via the injection port member 440 mounted to the injection block 451. In embodiments, a set of at least two different types of injection port members can be provided. For example, in embodiments at least one injection port member can have a through passage with an inner diameter that is different from one other injection port member. In other embodiments, at least one injection port member can include a restriction in its through passage that is not found in at least one other of the set of injection port members. Each such injection port member can be serially, threadedly mounted to the injection block 451 via the mating threaded surfaces such that the through passage of each is in fluid communication with the port passageway 444.

The port passageway 444 is disposed at a nominal ninety degree port angle θ to a discharge axis DA defined by the slurry passageway 443. In embodiments, the port angle θ can be in a range between forty-five degrees and one hundred thirty-five degrees. In embodiments, the port angle θ can be in a range between sixty degrees and one hundred twenty degrees. In embodiments, the port angle θ can be in a range between seventy-five degrees and one hundred, five degrees. In embodiments, the flow of additive(s) being conveyed to the injection block 451 is turbulent. Turbulent flow is maintained as the flow of additive(s) passes through the port passageway 444 into the slurry passageway 443 where it mixes with the base slurry coming from the mixer and travelling through the slurry passageway 443.

Referring to FIGS. 11 and 12, in the illustrated embodiment, the injection block 451 defines one port passageway 444 in fluid communication with the longitudinal through bore 455. Referring to FIG. 12, the injection block 451 defines a plurality of tapped fastener bores 445 configured to threadingly receive therein one of the fasteners 454 for mounting the slurry inlet member 447 and the slurry discharge member 449 to a respective one of the ends of the injection block 451, The port passageway 444 includes an internal threaded surface 490 configured to threadingly mate with an external surface of the injection port member such that the injection port member is fluidly associated with the port passageway to convey fluid passing therethrough to the slurry passageway.

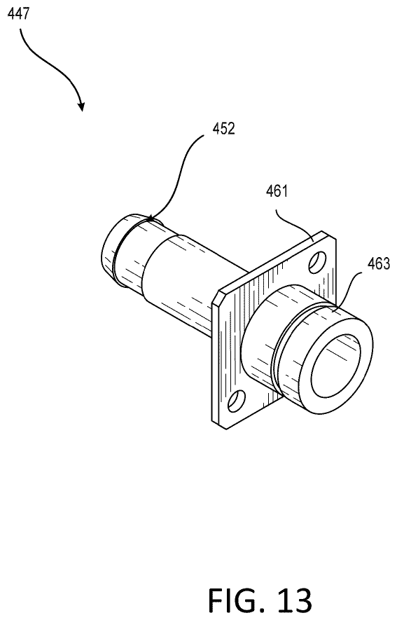

Referring to FIG. 13, a perspective view of the slurry inlet member 447 of the additive injection body 434 of FIG. 12 is shown. Referring to FIG. 14, a perspective view of the slurry discharge member 449 of the additive injection body 434 of FIG. 12 is shown. The illustrated slurry inlet member 447 and the slurry discharge member 449 of the injection body 434 each has an external barbed surface 452, 453 which is configured to promote a friction fit between the external barbed surface 452, 453 and an internal surface of a suitably-sized secondary discharge conduit. An adjustable hose clamp can be fitted to the exterior surface of the discharge conduit, placed in overlapping relationship with the portion of the respective member 447, 449 disposed within the slurry conduit, and tightened to further promote the retentive engagement of the discharge conduit to the injection body 434.

Referring to FIGS. 13 and 14, each of the slurry inlet member 447 and the slurry discharge member 449 includes a mounting flange 461, 462 for securing the respective member 447, 449 to the injection block 451 with the fasteners 454. An elastomeric o-ring 463, 464 can be fitted around an external surface of each of the slurry inlet member 447 and the slurry discharge member 449 for sealing engagement with the longitudinal through bore 455 of the injection block 451.

Referring to FIG. 11, the elastomeric o-rings 463, 464 are respectively disposed upstream and downstream of the port passageway 444 to effectively seal it to help prevent the flow of additive(s) from leaking from the injection block 451. The slurry inlet member 447 includes a terminal downstream portion 465 which includes an expanded internal cross-sectional area relative to its upstream portion 466. The slurry discharge member 449 has an internal cross-sectional area that is substantially the same as the expanded cross-sectional area of the terminal downstream portion 465 of the slurry inlet member 447.

In embodiments, the expansion zone created by the terminal downstream portion 465 of the slurry inlet member 447 and the slurry discharge member 449 can help to alleviate process problems that may occur as a result of introducing the flow of additive(s) via the port passageway 444 into the slurry passing through the slurry passageway 443.

In embodiments, the additive injection block 434 can be similar in other respects to the additive injection block 34 of FIG. 3 as will be appreciated by one skilled in the art. In embodiments, the additive injection block 434 can be similar in other respects to the additive injection block 134 of FIG. 7 as will be appreciated by one skilled in the art.

In embodiments, an additive injection system constructed according to principles of the present disclosure can be associated with a secondary discharge conduit of a conventional gypsum slurry mixer (e.g., a pin mixer) as is known in the art. An additive injection system constructed in accordance with principles of the present disclosure can advantageously be configured as a retrofit in an existing wallboard manufacturing system. The additive injection system can be used with components of a conventional discharge conduit.

In embodiments, a secondary slurry dispensing apparatus constructed in accordance with principles of the present disclosure can be placed in fluid communication with a slurry mixer to produce a cementitious slurry. In one embodiment, a slurry mixing and dispensing assembly includes a mixer, a main slurry dispensing apparatus, and a secondary slurry dispensing apparatus.

In embodiments, a mixing apparatus for mixing and dispensing a slurry includes a mixer having a mixer motor and a housing configured for receiving and mixing the slurry. The housing defines a chamber for holding the slurry, and can have a generally cylindrical shape. The housing can have an upper wall, a lower wall, and an annular peripheral wall. Calcined gypsum and water, as well as other materials or additives often employed in slurries to prepare gypsum products, can be mixed in the mixing apparatus. A first outlet, also referred to as a mixer outlet, a discha rge gate or a slot, can be provided in the peripheral wall for the discharge of a major portion of the cementitious slurry into the main slurry dispensing apparatus. A second mixer outlet can be provided in the peripheral wall for the discharge of a minor portion of the cementitious slurry into the secondary slurry dispensing apparatus. The secondary dispensing apparatus can include a cylindrical flexible, resilient tube or conduit having an inlet in slurry receiving communication with the second mixer outlet and an additive injection system constructed according to principles of the present disclosure.

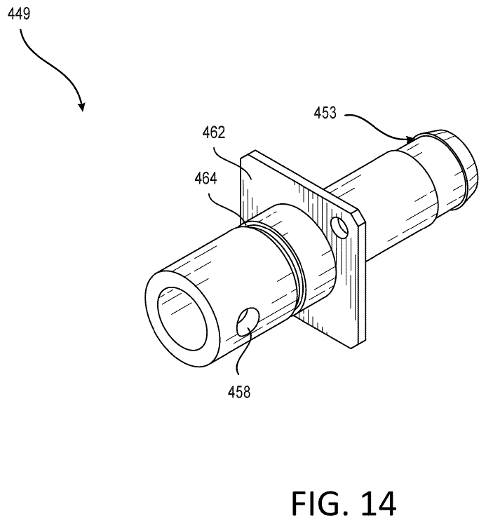

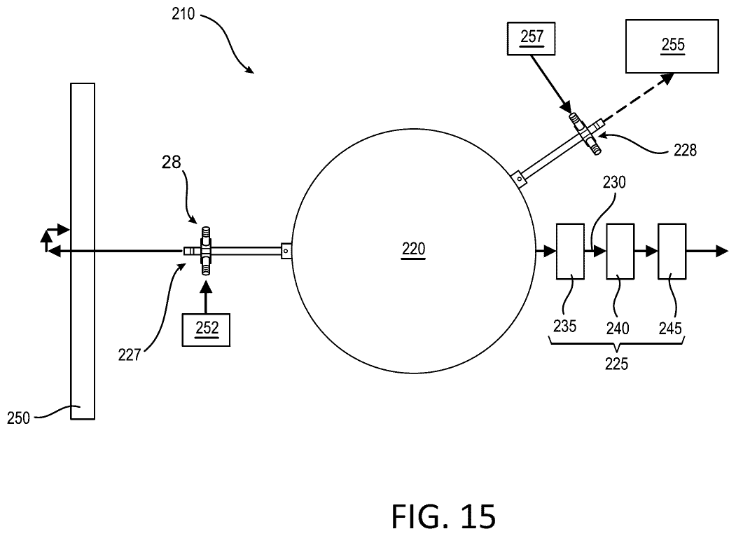

Referring to FIG. 15, an embodiment of a cementitious slurry mixing and dispensing assembly 210 constructed in accordance with principles of the present disclosure is shown. The cementitious slurry mixing and dispensing assembly 210 includes a slurry mixer 220 in fluid communication with a main discharge conduit 225 and a pair of auxiliary discharge conduits 227,228.

The slurry mixer 220 is adapted to agitate water and a cementitious material to form aqueous cementitious slurry. The slurry mixer 220 is in fluid communication with the main discharge conduit 225 and the pair of secondary discharge conduits 227, 228. Both the water and the cementitious material can be supplied to the mixer 220 via one or more inlets as is known in the art. In embodiments, any other suitable slurry additive can be supplied to the mixer 220 as is known in the art of manufacturing cementitious products. Any suitable mixer (e.g., a pin mixer) can be used as will be appreciated by one skilled in the art.

The mixer 220 includes a housing and an agitator disposed within the housing. The housing has a main outlet and a pair of secondary outlets. The agitator is configured to agitate water and a cementitious material to form an aqueous cementitious slurry.

The main discharge conduit 225 is configured to deliver a main flow of cementitious slurry from the mixer downstream to a further manufacturing station (e.g., upon a moving web of cover sheet material in embodiments used to produce gypsum wallboard). The main discharge conduit 225 is in fluid communication with the mixer 220. In embodiments, the main discharge conduit 225 can comprise any suitable discharge conduit component as will be appreciated by one skilled in the art. The illustrated main discharge conduit 225 includes a delivery conduit 230, a foam injection system 235, a flow-modifying element 240, and a slurry distributor 245.

The delivery conduit 230 defines a slurry passage. The conduit 230 is connected to the mixer 220 such that the slurry passage is in fluid communication with the main outlet. In embodiments, the delivery conduit 230 can be made from any suitable material and can have different shapes. In some embodiments, the delivery conduit 230 can comprise a flexible conduit.

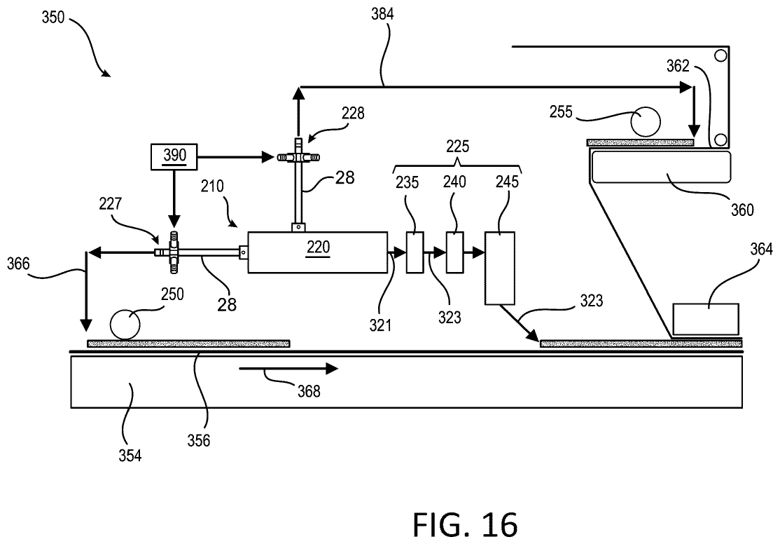

In embodiments, the flow-modifying element 240 is a part of the main discharge conduit 225 and is adapted to modify a flow of cementitious slurry from the mixer 220 through the main discharge conduit 225. The flow-modifying element 240 is disposed downstream of the foam injection system 235 relative to a flow direction of the flow of cementitious slurry from the mixer 220 through the main discharge conduit 225. In embodiments, one or more flow-modifying elements 240 can be associated with the main discharge conduit 225 and adapted to control a main flow of slurry discharged from the slurry mixer 220. The flow-modifying element(s) 240 can be used to control an operating characteristic of the main flow of aqueous cementitious slurry. In the illustrated embodiment of FIGS. 15 and 16, the flow-modifying element(s) 240 is associated with the main discharge conduit 225. Examples of suitable flow-modifying elements include volume restrictors, pressure reducers, constrictor valves, canisters etc., including those described in U.S. Pat. Nos. 6,494,609; 6,874,930; 7,007,914; and 7,296,919, for example.

In embodiments, the slurry distributor 245 can be any suitable terminal portion of a conventional discharge conduit, such as a length of conduit in the form of a flexible hose or a component commonly referred to as a “boot.” In embodiments, the boot can be in the form of a multi-leg discharge boot.

In other embodiments, the slurry distributor 245 can be similar to those shown and described in U.S. Patent Applications 2012/0168527; 2012/0170403; 2013/0098268; 2013/0099027; 2013/0099418; 2013/0100759; 2013/0216717; 2013/0233880; and 2013/0308411. In some of such embodiments, the main discharge conduit 225 can include suitable components for splitting a main flow of cementitious slurry into two flows which are re-combined in the slurry distributor 245.

In embodiments, the foam injection system 235 can be arranged with at least one of the mixer 220 and the delivery conduit 230. The foam injection system 235 can include a foam source (e.g., such as a foam generation system configured as known in the art) and a foam supply conduit.

In embodiments, any suitable foam source and foaming agent can be used.

Preferably, the aqueous foam is produced in a continuous manner in which a stream of a mix of foaming agent and water is directed to a foam generator, and a stream of the resultant aqueous foam leaves the generator and is directed to and mixed with the cementitious slurry. Some examples of suitable foaming agents are described in U.S. Pat. Nos. 5,683,635 and 5,643,510, for example.

An aqueous foam supply conduit can be in fluid communication with at least one of the slurry mixer 220 and the discharge conduit 230. An aqueous foam from a source can be added to the constituent materials through the foam supply conduit at any suitable location downstream of the mixer and/or in the mixer itself to form a foamed cementitious slurry that is provided to the slurry distributor 240. In the illustrated embodiment, the foam supply conduit is disposed downstream of the slurry mixer and is associated with the discharge conduit 230. In the illustrated embodiment, the aqueous foam supply conduit has a manifold-type arrangement for supplying foam to a plurality of foam injection ports defined within an injection ring or block associated with the delivery conduit, as described in U.S. Pat. No. 6,874,930, for example.

In other embodiments, one or more foam supply conduits can be provided that is in fluid communication with the mixer 220. In yet other embodiments, the aqueous foam supply conduit(s) can be in fluid communication with the slurry mixer alone. As will be appreciated by those skilled in the art, the means for introducing aqueous foam into the cementitious slurry in the cementitious slurry mixing and dispensing assembly, including its relative location in the assembly, can be varied and/or optimized to provide a uniform suspension of aqueous foam in the cementitious slurry to produce board that is fit for its intended purpose.

As one of ordinary skill in the art will appreciate, one or both of the webs of cover sheet material can be pre-treated with a very thin relatively denser layer of gypsum slurry (relative to the gypsum slurry comprising the core), often referred to as a skim coat in the art, and/or hard edges, if desired. To that end, the first auxiliary discharge conduit 227 is adapted to deposit a stream of dense aqueous calcined gypsum slurry (i.e., a “face skim coat/hard edge stream”) that is relatively denser than the main flow of aqueous calcined gypsum slurry discharged from the main discharge conduit 225. The first auxiliary discharge conduit 227 can deposit the face skim coat/hard edge stream upon a moving web of cover sheet material upstream of a skim coat roller 250 that is adapted to apply a skim coat layer to the moving web of cover sheet material and to define hard edges at the periphery of the moving web by virtue of the width of the roller being less than the width of the moving web as is known in the art. Hard edges can be formed from the same dense slurry that forms the thin dense layer by directing portions of the dense slurry around the ends of the roller used to apply the dense layer to the web.

The first auxiliary discharge conduit 227 can include an additive injection system 28 similar in construction and function as the one shown and described herein in connection with FIG. 3. An additive(s) supply 252 can be placed in fluid communication with the additive injection system 28 of the first auxiliary discharge conduit 227 to inject at least one additive into the face skim coat/hard edge stream. In embodiments, the additive(s) supply 252 comprises fiber.

The second auxiliary discharge conduit 228 is adapted to deposit a stream of dense aqueous calcined gypsum slurry (i.e., a “back skim coat stream”) that is relatively denser than the main flow of aqueous calcined gypsum slurry discharged from the main discharge conduit 225. The second auxiliary discharge conduit 228 can deposit the back skim coat stream upon a second moving web of cover sheet material upstream (in the direction of movement of the second web) of a skim coat roller 255 that is adapted to apply a skim coat layer to the second moving web of cover sheet material as is known in the art (see FIG. 16 also).

The second auxiliary discharge conduit 228 can include an additive injection system 28 similar in construction and function as the one shown and described herein in connection with FIG. 3. An additive(s) supply 257 can be placed in fluid communication with the additive injection system 28 of the second auxiliary discharge conduit 228 to inject at least one additive into the back skim coat stream. In embodiments, the additive(s) supply 257 comprises fiber.

In other embodiments, one or both of the auxiliary discharge conduits can include another embodiment of an additive injection system constructed according to principles of the present disclosure. In other embodiments, separate auxiliary discharge conduits with an additive injection system constructed according to principles of the present disclosure can be connected to the mixer to deliver one or more separate edge streams to the moving web of cover sheet material. In other embodiments, the additive injection system can be omitted from one of the first and second auxiliary discharge conduits 227, 228. In other embodiments, the second auxiliary discharge conduit 228 (and its associated additive injection system) can be omitted.

Referring to FIG. 16, an exemplary embodiment of a wet end 350 of a gypsum wallboard manufacturing line is shown. The illustrated wet end 350 includes the cementitious slurry mixing and dispensing assembly 210, a hard edge/face skim coat roller 250 disposed upstream of the slurry distributor 245 of the main discharge conduit 225 and supported over a forming table 354 such that a first moving web 356 of cover sheet material is disposed therebetween, a back skim coat roller 255 disposed over a support element 360 such that a second moving web 362 of cover sheet material is disposed therebetween, and a forming station 364 adapted to shape the preform into a desired thickness. The skim coat rollers 250, 255, the forming table 354, the support element 360, and the forming station 364 can all comprise conventional equipment suitable for their intended purposes as is known in the art. The wet end 350 can be equipped with other conventional equipment as is known in the art.

Water and calcined gypsum can be mixed in the mixer 220 to form an aqueous calcined gypsum slurry. In some embodiments, the water and calcined gypsum can be continuously added to the mixer in a water-to-calcined gypsum ratio from 0.5 to 1.3, and in other embodiments of 0.75 or less.

Gypsum board products are typically formed “face down” such that the advancing web 356 serves as the “face” cover sheet of the finished board. A face skim coat/hard edge stream 366 (a layer of denser aqueous calcined gypsum slurry relative to the main or core flow of aqueous calcined gypsum slurry) can be applied to the first moving web 356 upstream of the hard edge/face skim coat roller 250, relative to the machine direction 368, to apply a skim coat layer to the first web 356 and to define hard edges of the board.

The foam injection system 235 can be used to inject aqueous foam into the calcined gypsum slurry produced by the mixer 220. A main flow 321 of aqueous calcined gypsum slurry is discharged from the mixer 220 into the main discharge conduit 225. Aqueous foam is injected into the main flow 321 of aqueous calcined gypsum slurry via the foam injection system 235 to form a flow 323 of foamed calcined gypsum slurry. The main flow 323 of foamed calcined gypsum slurry can be acted upon by one or more flow-modifying elements 240 and discharged from the slurry distributor 245 of the main discharge conduit 225 upon the first moving web 356.

The face skim coat/hard edge stream 366 can be deposited from the mixer 220 at a point upstream, relative to the direction of movement of the first moving web 356 in the machine direction 368, of where the flow 323 of foamed calcined gypsum slurry is discharged from the main discharge conduit 225 upon the first moving web 356. A back skim coat stream 384 (a layer of denser aqueous calcined gypsum slurry relative to the main flow of foamed calcined gypsum slurry) can be applied to the second moving web 362. The back skim coat stream 384 can be deposited from the mixer 220 at a point upstream, relative to the direction of movement of the second moving web 362, of the back skim coat roller 255. The second moving web 362 of cover sheet material can be placed upon the foamed slurry discharged from the main discharge conduit 225 upon the advancing first web 356 to form a sandwiched wallboard preform that is fed to the forming station 364 to shape the preform to a desired thickness. In embodiments, fiber, starch, aqueous foam, or other additives 390 can be added to the slurry comprising the face skim coat and/or back skim coat via the additive injection systems 28 respectively associated with the first and second auxiliary discharge conduits 227, 228.

The main flow 323 of cementitious slurry has a first volumetric flow rate, the face skim coat/hard edge stream has a second volumetric flow rate, and the back skim coat stream 384 has a third volumetric flow rate. In embodiments, the first volumetric flow rate is greater than the second volumetric flow rate, and the first volumetric flow rate is greater than the second volumetric flow rate. In embodiments, the second volumetric flow rate is greater than the third volumetric flow rate.

The wet end 350 can be incorporated with known equipment to be used as a manufacturing line. For example, board manufacturing techniques described in, for example, U.S. Pat. No. 7,364,676 and U.S. Patent Application Publication 2010/0247937 can be used with the wet ends 350.

Board can be made with different dimensions, depending on, e.g., product type and market. The board can have any suitable width (e.g., 48 inches to 54 inches), length (e.g., 96 inches to 192 inches), and thickness (e.g., ¼ inch, ⅜ inch, ½ inch, ⅝ inch, ¾ inch, 1 inch, etc.). Dimensions in different markets may vary slightly as well understood in the art.

The dense layer in accordance with embodiments can also have any suitable dimensions. Generally, the dense layer contributes a much smaller proportion of the total board weight and thickness because it can be relatively thin. Once the board is made, microscopy may be performed at various positions along the whole width of the board to determine the dense layer thickness. Any form of microscopy can be used, such as optical or scanning electron microscopy (SEM), to determine thickness of various layers in, e.g., a board sample.

With respect to an optical microscope, the dense layer of the board sample can be observed even at lower magnifications. If desired, any suitable dye, including food dyes, can be added to the board sample to assist with delineation between layers of the board. If desired, a fluorescent dye can optionally be used, but is not required. In the case of SEM, a dye is generally not needed as the density difference between layers is apparent under the resolution power of an SEM. To determine the thickness of the layer, an image analysis software (e.g., ImageJ) or other suitable method can be used to identify distances between two points. The layer thickness is the distance between the beginning of the layer/end of paper and the end of the layer/beginning of the core. It can be measured at multiple positions on the board. Thickness is measured when the board is dry using the microscopy test, unless otherwise indicated.

During the manufacturing process other tests can be used to determine the thickness, density, and hardness of the core and dense layer. During manufacture, the thickness of the dense layer is measured using a thickness gauge (e.g., a Wet Film Thickness Gauge Comb, commercially available from TCP Global, San Diego, California) which is used periodically at different positions along the dense layer. Thickness is measured by noting the amount of the gauge that was submerged into the dense layer slurry when inserted and removed at a 90° angle.

During the manufacturing process the densities of both the dense layer and core can be monitored by measuring the wet densities as follows. Slurry is poured into a cup with a known volume and the weight is recorded. Periodically, samples of both the dense and core layer slurries are poured into molds (cubes or discs) and both the wet and dry densities are estimated by measuring both the weights and dimensions before and after drying.

The board thickness can vary depending on the type of application for the product (e.g., regular board at ½ inch or fire-resistant board at ⅝ inch, i.e., 0.625 inch). For example, in some embodiments, for a nominal I/inch thick board, the dense layer can have a dry thickness of from 0.02 inches to 0.05 inches (e.g., from 0.02 inches to 0.04 inches, or from 0.025 inches to 0.035 inches). For boards of other thickness, the dense layer can be adjusted to a thickness consistent with the exemplary thicknesses mentioned for 1 inch board, which adjustments can readily be calculated by one of ordinary skill in the art and contemplated herein.

In some embodiments, the dense layer contributes from 2% to 15% of the total thickness of the board, e.g., from 2% to 10%, from 2% to 8%, from 2% to 5%, from 5% to 15%, from 5% to 10%, from 5% to 8%, from 8% to 15%, from 10% to 15%, etc. If the second dense gypsum is included, it can be provided in, e.g., any of these dimensions if desired.

Board weight is a function of thickness. Since boards are commonly made at varying thickness, board density is used herein as a measure of board weight. The advantages of the use of the fiber reinforced dense layer in accordance with embodiments of the disclosure can be seen across various board densities, e.g., 40 pcf or less, such as from 10 pcf to 40 pcf, from 12 pcf to 40 pcf, from 16 pcf to 35 pcf, from 20 pcf to 40 pcf, from 24 pcf to 37 pcf, etc. However, preferred embodiments of the disclosure have particular utility at lesser densities where the enhanced strength provided by the fiber reinforced dense layer advantageously enable the production of lower weight board with good strength. For example, in some embodiments, board density can be, e.g. from 12 pcf to 35 pcf, from 12 pcf to 30 pcf, from 12 pcf to 27 pcf, from 16 pcf to 30 pcf, from 16 pcf to 27 pcf, from 16 pcf to 24 pcf, from 18 pcf to 30 pcf, from 18 pcf to 27 pcf, from 20 pcf to 30 pcf, from 20 pcf to 27 pcf, from 24 pcf to 35 pcf, from 27 pcf to 35 pcf, from 27 pcf to 34 pcf, from 27 pcf to 30 pcf, from 30 pcf to 34 pcf, etc.

The dense layer has a considerably greater density than the density of the board core. For example, the dense layer can have a density of from 40 pcf to 70 pcf (e.g., from 45 pcf to 65 pcf, or from 50 pcf to 60 pcf). The use of the dense layer with fiber as described herein allows for the use of a lesser board core, and hence a lighter weight and lesser density board overall.

The core can have any suitable density but lesser densities can be used, e.g., a core density of 35 pcf or less (e.g., 31 pcf or less, or 27 pcf or less). For example, the core can have a density of from 15 pcf to 35 pcf (e.g., from 20 pcf to 31 pcf, from 20 pcf to 24 pcf, or from 24 pcf to 27 pcf, etc.).

In some embodiments, the difference in density between the dense layer and the core is desirably substantial, e.g., at least 10 pcf, at least 15 pcf, at least 20 pcf, at least 25 pcf, or at least 30 pcf (such as from 10 pcf to 50 pcf, from 10 pcf to 40 pcf, from 10 pcf to 30 pcf, from 10 pcf to 20 pcf, from 15 pcf to 50 pcf, from 15 pcf to 40 pcf, from 15 pcf to 30 pcf, from 20 pcf to 50 pcf, from 20 pcf to 40 pcf, from 20 pcf to 30 pcf, from 25 pcf to 50 pcf, from 25 pcf to 40 pcf, from 20 pcf to 30 pcf, from 25 pcf to 35 pcf, etc.). The density ratio of the dense layer to the core can be any suitable ratio. For example, in some embodiments, the density ratio of the dense layer to the core can be from 1,25:1 to 5:1, such as, from 1,25:1 to 4:1, from 1.25;1 to 3:1, from 1.25:1 to 2:1, from 1.5:1 to 5:1, from 1.5:1 to 4:1, from 1,5:1 to 3:1, from 2;1 to 5:1, from 2:1 to 4:1, from 2:1 to 3:1, from 3:1 to 5:1, or from 3:1 to 4;1, etc.

Board prepared with fiber reinforced dense layer as described herein exhibit good strength. For example, in some embodiments, board according to the disclosure meets test protocols according to ASTM Standard C473-10, method B. In this regard, in some embodiments, when the board is cast at a thickness of ½ inch, the board has a nail pull resistance of at least 65 lb. as determined according to ASTM C 473-10, method B (e.g., at least 68 lb., at least 70 lb., at least 72 lb., at least 75 lb., at least 77 lb., in each case with any suitable upper limit, such as 110 lb. or greater, etc.). With respect to flexural strength, in some embodiments, when cast in a board of ½ inch thickness, the board has a flexural strength of at least 36 lb. in a machine direction (e.g., at least 38 lb., at least 40 lb, etc., in each case with any suitable upper limit, such as 80 lb. or greater, etc.) and/or at least 107 lb. (e.g., at least 110 lb., at least 112 lb., etc., in each case with any suitable upper limit, such as 140 lb. or greater, etc.) in a cross-machine direction as determined according to the ASTM standard C473. Due at least in part to the fiber reinforced dense layer in accordance with embodiments of the disclosure, these standards can be met even with respect to lesser density board (e.g., 35 pcf or less) as described herein.

### Aspects

The disclosure is further illustrated by the following exemplary aspects. However, the disclosure is not limited by the following aspects,

(1) Methods of preparing gypsum board, as described herein.

(2) A method of making gypsum board comprising: preparing a slurry in a mixer, the slurry comprising water, stucco, and cellulosic fiber in an amount of 2% by weight of the stucco or less; discharging a majority portion of the slurry from the mixer to form a core slurry; extracting a minority portion of the slurry from the mixer to form a dense layer slurry; applying the dense layer slurry in bonding relation to a first cover sheet; applying a first surface of the core slurry in bonding relation to the dense layer; and applying a second cover sheet in bonding relation to a second surface of the core slurry; the board having a density of 32 pcf or less (e.g. 30 pcf or less) and a nail pull resistance of at least 65 lb (e.g. at least 72 lb) according to ASTM 473-10, method B.

(3) The method of aspect 2, wherein the extracting forms a second dense layer slurry, the method further comprising disposing the second dense layer slurry between the second cover sheet and the second surface of the core slurry.

(4) The method of aspects 2 or 3, wherein cellulosic fiber is not added to the extracted dense layer slurry.

(5) The method of any one of aspects 2-4, wherein cellulosic fiber is not added to the discharged core slurry.

(6) The method of any one of aspects 2-5, wherein cellulosic fiber is not added to the extracted dense layer slurry or to the discharged core slurry.

(7) The method of any one of aspects 3-6, wherein cellulosic fiber is added to the second dense layer slurry.

(8) The method of any one of aspects 3-7, wherein cellulosic fiber is not added to the second dense layer slurry.

(9) The method of aspects 2-8, wherein foaming agent is added to the discharged core slurry.

(10) The method of aspects 2-8, wherein foaming agent is not added to the discharged core slurry.

(11) The method of aspects 2-10, wherein foaming agent is added to the extracted dense layer slurry

(12) The method of aspects 2-10, wherein foaming agent is not added to the extracted dense layer slurry.

(13) The method of aspects 2-12, wherein the cellulosic fiber is added to the mixer in an amount of 0.5% to 2% by weight of the stucco.

(14) The method of aspects 2-12, wherein the cellulosic fiber is added to the mixer in an amount of 0.5% to 1.5% by weight of the stucco.

(15) The method of aspects 2-12, wherein the cellulosic fiber is added to the mixer in an amount of 1% to 2% by weight of the stucco.

(16) The method of aspects 2-15, wherein the cellulosic fiber is hammer milled.

(17) The method of any one of aspects 1-16, wherein the cellulosic fiber contains fibers that do not pass through the mesh of a U14 Clark Classifier, according to TAPPI Standard T-233 (2006 Edition).

(18) The method of any one of aspects 1-17, wherein the cellulosic fiber contains fibers having an average length of at least 1.41 mm.

(19) The method of any one of aspects 1-18, wherein the cellulosic fiber contains flakes that do not pass through the mesh of a U14 Clark Classifier, according to TAPPI Standard T-233 (2006 Edition).

(20) The method of any one of aspects 1-19, wherein the cellulosic fiber contains flakes having an average length of at least 1.41 mm.

(21) The method of aspects 2-20, wherein the cellulosic fiber is added to the dense layer slurry and/or core slurry by injection of a wet pulp.

(22) The method of aspect 21, wherein the wet pulp contains from 0.5% to 10%, such as from 1% to 6%, or from 2% to 5%, of cellulosic fiber in water.

(23) The method of aspects 21 or 22, wherein the wet pulp is prepared in a hydrapulper.

(24) The method of any one of aspects 21-23, wherein the wet pulp is injected into the mixer via one or more injection hose producing flow of the pulp sufficient to form enough shear force in the injection hose to uniformly distribute the cellulosic fiber in dense layer slurry and/or core slurry.

(25) The method of any one of aspects 1-24, wherein the slurry further comprises glass fiber.

(26) The method of aspect 25, wherein the glass fiber is in an amount of from 0.1% to 1%, such as from 0.1% to 0.7%, from 0.1% to 0.5%, from 0.2% to 1%, from 0.2% to 0.7%, or from 0.2% to 0.5% by weight of the stucco

(27) The method of aspects 25 or 26, wherein the weight ratio of cellulosic fiber to fiberglass is from 1:1 to 5:1, such as from 1.5:1 to 5:1, from 1.5:1 to 4:1, from 1.5:1 to 3:1, from 1.5:1 to 2:1, from 2:1 to 5:1, from 2:1 to 3:1, from 3:1 to 5:1, or from 3:1 to 4:1.

(28) The method of any one of aspects 1-27, wherein the slurry further comprises alum.

(29) The method of any one of aspects 2-28, wherein the cellulosic fiber includes paper fibers, wood fibers, straw fibers, grass fibers, cotton fibers, and/or rayon fibers.

(30) The method of aspect 29, wherein the cellulosic fiber includes paper fiber.

(31) The method of aspects 29 or 30, wherein the cellulosic fiber includes grass fiber.

(32) The method of aspect 31, wherein the grass fiber includes bamboo fibers.

(33) The method of aspect 31, wherein the grass fiber includes hemp fibers.

(34) The method of aspect 31, wherein the grass fiber includes jute fibers.

(35) The method of aspect 31, wherein the grass fiber includes kenaf fibers.

(36) The method of any one of aspects 1-35, wherein the slurry further comprises glass fiber.

(37) The method of aspect 36, wherein the glass fiber is in an amount of from 0.1% to 1%, such as from 0.1% to 0.7%, from 0.1% to 0.5%, from 0.2% to 1%, from 0.2% to 0.7%, or from 0.2% to 0.5% by weight of the stucco.

(38) The method of aspects 35 or 36, wherein the weight ratio of cellulosic fiber to fiberglass is from 1:1 to 5:1, such as from 1.5:1 to 5:1, from 1.5:1 to 4:1, from 1.5:1 to 3:1, from 1.5:1 to 2:1, from 2:1 to 5:1, from 2:1 to 3:1, from 3:1 to 5:1, or from 3:1 to 4:1.

(39) The method of any one of aspects 1-38, wherein the slurry further comprises alum.

(40) A method of making gypsum board comprising: preparing a core slurry comprising water, stucco, foaming agent, and cellulosic fiber and strength-enhancing starch in an amount of 4% by weight of the stucco or less; preparing a dense layer slurry comprising water and stucco; adding cellulosic fiber to the dense layer slurry in an amount of 2% by weight of the stucco or less; applying the dense layer slurry in bonding relation to a first cover sheet, applying a first surface of the core slurry in bonding relation to the dense layer; and applying a second cover sheet in bonding relation to a second surface of the core slurry; the board having a density of 32 pcf or less (e.g. 30 pcf or less) and a nail pull resistance of at least 65 lb (e.g. at least 72 lb) according to ASTM 473-10, method B.

(41) The method of aspect 40, wherein the dense layer slurry excludes foaming agent.

(42) The method of aspects 40 or 41, wherein the weight ratio of the cellulosic fiber provided in the dense layer slurry relative to the core slurry is at least 1.8 (e.g., from 1,8 to 4,5, such as from 1.8 to 4, from 1.8 to 3, from 1,8 to 2.5, or from 1.5 to 2.3).

(43) The method of any one of aspects 40-42, wherein the weight ratio of the cellulosic fiber provided in the dense layer slurry relative to the core slurry is at least 2 (e.g. from 2 to 4.5, such as from 2 to 4, from 2 to 3, or from 2 to 2.5).

(44) The method of any one of aspects 40-43, wherein the weight ratio of the cellulosic fiber provided in the dense layer slurry relative to the core slurry is at least 2.2 (e.g., from 2.2 to 4.5, such as from 2.2 to 4, from 2.2 to 3, or from 2.2 to 2.5).

(45) The method of any one of aspects 40-44, wherein the cellulosic fiber is added to the core slurry in an amount of 0.5% to 1% by weight of the stucco.

(46) The method of any one of aspects 40-45, wherein the cellulosic fiber is added to the dense layer slurry and/or core slurry in dry form.

(47) The method of aspect 46, wherein the cellulosic fiber is hammer milled.

(48) The method of any one of aspects 40-47, wherein the cellulosic fiber contains fibers that do not pass through the mesh of a U14 Clark Classifier, according to TAPPI Standard T-233 (2006 Edition).

(49) The method of any one of aspects 40-48, wherein the cellulosic fiber contains fibers having an average length of at least 1.41 mm.

(50) The method of any one of aspects 40-49, wherein the cellulosic fiber contains flakes that do not pass through the mesh of a U14 Clark Classifier, according to TAPPI Standard T-233 (2006 Edition)

(51) The method of any one of aspects 40-47 and 50, wherein the cellulosic fiber contains flakes having an average length of at least 1.41 mm.

(52) The method of any one of aspects 40-51, wherein the cellulosic fiber is added to the dense layer slurry and/or core slurry by injection of a wet pulp.

(53) The method of aspect 52, wherein the wet pulp contains from 0.5% to 10%, such as from 1% to 6%, or from 2% to 5%, of cellulosic fiber in water.

(54) The method of aspects 52 or 53, wherein the wet pulp is prepared in a hydrapulper.

(55) The method of any one of aspects 52-54, wherein the wet pulp is injected into the dense layer slurry and/or core slurry via one or more injection hose producing flow of the pulp sufficient to form enough shear force in the injection hose to uniformly distribute the cellulosic fiber in dense layer slurry and/or core slurry.

(56) The method of any one of aspects 47-55, wherein the wet pulp is mixed for an amount of time dependent on the temperature of the water in the wet pulp, and wherein it is mixed for a longer time period than the same pulp using water at a higher temperature.

(57) The method of any one of aspects 47-56, wherein an adjustment coefficient for the relationship between temperature (° F.) and pulping time according to linear regression analysis is from 0 to −0.1.

(58) The method of any one of aspects 47-57, wherein an adjustment coefficient for the relationship between temperature (° F.) and pulping time according to linear regression analysis is from −0.019 to −0.033.

(59) The method of any one of aspects 47-58, wherein an adjustment coefficient for the relationship between temperature (° F.) and pulping time according to linear regression analysis is from −0.0009 to −0.0025.

(60) The method of any one of aspects 40-59, wherein the dense layer slurry includes the same or lower amount of starch, dispersant, accelerator, retarder, and polyphosphate, as compared with the core slurry.

(61) The method of any one of aspects 40-60, wherein the cellulosic fiber is recycled or waste.

(62) The method of any one of aspects 40-61, wherein the cellulosic fiber is chopped.

(63) The method of any one of aspects 40-62, wherein the cellulosic fiber has a length of from 500 microns to 3000 microns, such as from 1000 microns to 2000 microns.

(64) The method of any one of aspects 40-63, wherein the dense layer slurry contains from 1.3% to 1.7% of cellulosic fiber by weight of the stucco, and the core slurry contains from 0.5% to 0.8% of cellulosic fiber by weight of the stucco.

(65) The method of any one of aspects 49-64, wherein the strength enhancing starch is included in an amount that is from 30% to 200% more than the amount of the fiber.

(66) The method of any one of aspects 40-65, wherein the slurry further comprises glass fiber,

(67) The method of aspect 66, wherein the glass fiber is in an amount of from 0.1% to 1%, such as from 0.1% to 0.7%, from 0.1% to 0.5%, from 0.2% to 1%, from 0.2% to 0.7%, or from 0.2% to 0.5% by weight of the stucco.

(68) The method of aspects 66 or 67, wherein the weight ratio of cellulosic fiber to fiberglass is from 1:1 to 5:1, such as from 1.5:1 to 5:1, from 1.5:1 to 4:1, from 1,5:1 to 3:1, from 1.5:1 to 2:1, from 2:1 to 5:1, from 2:1 to 3:1, from 3:1 to 5:1, or from 3:1 to 4:1.

(69) The method of any one of aspects 1-68, wherein the slurry further comprises alum.

(70) The method of any one of aspects 40-69, wherein the cellulosic fiber includes paper fibers, wood fibers, straw fibers, grass fibers, cotton fibers, and/or rayon fibers.

(71) The method of any one of aspects 40-70, wherein the cellulosic fiber includes paper fiber.

(72) The method of any one of aspects 40-71, wherein the cellulosic fiber includes grass fiber.

(73) The method of aspect 72, wherein the grass fiber includes bamboo fibers.

(74) The method of aspect 72, wherein the grass fiber includes hemp fibers.

(75) The method of aspect 72, wherein the grass fiber includes jute fibers.

(76) The method of aspect 72, wherein the grass fiber includes kenaf fibers.

(77) A method of making gypsum board comprising: preparing a core slurry comprising water, stucco, foaming agent, and cellulosic fiber in an amount of 0.5% to 1.5% by weight of the stucco; preparing a dense layer slurry comprising water and stucco, the dense layer slurry excluding foaming agent; adding cellulosic fiber to the dense layer slurry in an amount of 0.7% to 2% by weight of the stucco; applying the dense layer slurry in bonding relation to a first cover sheet; applying a first surface of the core slurry in bonding relation to the dense layer; and applying a second cover sheet in bonding relation to a second surface of the core slurry; wherein: the dense layer slurry preferentially contains a greater concentration of the cellulose fibers than the core slurry, the dense layer slurry includes the same or lower amount of starch, dispersant, accelerator, retarder, and polyphosphate, as compared with the core slurry, the board having a density of 32 pcf or less (e.g. 30 pcf or less) and a nail pull resistance of at least 65 lb (e.g. at least 72 lb) according to ASTM 473-10, method B.

(78) The method of aspect 77, wherein the cellulosic fiber is added to the dense layer slurry and core slurry in dry form.

(79) The method of aspect 77 or 78, wherein the cellulosic fiber is hammer milled.

(80) The method of any one of aspects 77-79, wherein the cellulosic fiber contains fibers that do not pass through the mesh of a U14 Clark Classifier, according to TAPPI Standard T-233 (2006 Edition).

(81) The method of any one of aspects 77-80, wherein the cellulosic fiber contains fibers having an average length of at least 1.41 mm.

(82) The method of any one of aspects 77-81, wherein the cellulosic fiber contains flakes that do not pass through the mesh of a U14 Clark Classifier, according to TAPPI Standard T-233 (2006 Edition).

(83) The method of any one of aspects 77-82, wherein the cellulosic fiber contains flakes having an average length of at least 1.41 mm.

(84) The method of any one of aspects 77-83, wherein the cellulosic fiber is added to the dense layer slurry and/or core slurry by injection of a wet pulp.

(85) The method of aspect 84, wherein the wet pulp contains from 0.5% to 10%, such as from 1% to 6%, or from 2% to 5%, of cellulosic fiber in water.

(86) The method of aspects 84 or 85, wherein the wet pulp is prepared in a pulper.

(87) The method of any one of aspects 84-86, wherein the wet pulp is injected into the dense layer slurry and/or core slurry via one or more injection hose producing flow of the pulp sufficient to form enough shear force in the injection hose to uniformly distribute the cellulosic fiber in dense layer slurry and/or core slurry.

(88) The method of any one of aspects 84-87, wherein the wet pulp is mixed for an amount of time dependent on the temperature of the water in the wet pulp, and wherein it is mixed for a longer time period than the same pulp using water at a higher temperature.

(89) The method of aspect 88, wherein an adjustment coefficient for the relationship between temperature (° F.) and pulping time according to linear regression analysis is from 0 to −0.1.

(90) The method of aspect 88, wherein an adjustment coefficient for the relationship between temperature (° F.) and pulping time according to linear regression analysis is from −0.019 to −0.033.

(91) The method of aspect 88, wherein an adjustment coefficient for the relationship between temperature (° F.) and pulping time according to linear regression analysis is from −0.0009 to −0.0025.

(92) The method of any one of aspects 77-91, wherein the cellulosic fiber includes paper fibers, wood fibers, straw fibers, grass fibers, cotton fibers, and/or rayon fibers.

(93) The method of any one of aspects 77-92, wherein the cellulosic fiber includes paper fiber.

(94) The method of any one of aspects 77-93, wherein the cellulosic fiber includes grass fiber.

(95) The method of any one of aspects 77-94, wherein the grass fiber includes bamboo fibers.

(96) The method of any one of aspects 77-95, wherein the grass fiber includes hemp fibers.

(97) The method of any one of aspects 77-96, wherein the grass fiber includes jute fibers.

(98) The method of any one of aspects 77-97, wherein the grass fiber includes kenaf fibers.

(99) The method of any one of aspects 77-98, wherein the slurry further comprises glass fiber.

(100) The method of aspect 99, wherein the glass fiber is in an amount of from 0.1% to 18%, such as from 0.1% to 0.7%, from 0.1% to 0.5%, from 0.2% to 1%, from 0.2% to 0.7%, or from 0.2% to 0.5% by weight of the stucco.

(101) The method of aspects 99 or 100, wherein the weight ratio of cellulosic fiber to fiberglass is from 1:1 to 5:1, such as from 1,5:1 to 5:1, from 1.5:1 to 4:1, from 1.5;1 to 3:1, from 1.5:1 to 2:1, from 2:1 to 5:1, from 2:1 to 3:1, from 3:1 to 5:1, or from 3:1 to 4:1.

(102) The method of any one of aspects 77-101, wherein the slurry further comprises alum.

(103) A method of making gypsum board comprising: preparing a core slurry comprising water, stucco, foaming agent, and optionally cellulosic fiber (e.g. in an amount of 0.5% to 1.5% by weight of the stucco); preparing a dense layer slurry comprising water or stucco, and cellulosic fiber in an amount of 0.7% to 2% by weight of the stucco, the dense layer slurry optionally excluding foaming agent; applying the dense layer slurry in bonding relation to a first cover sheet; applying a first surface of the core slurry in bonding relation to the dense layer; and applying a second cover sheet in bonding relation to a second surface of the core slurry; wherein: the dense layer slurry optionally preferentially contains a greater concentration of the cellulosic fibers than the core slurry, the dense layer slurry optionally includes the same or lower amount of starch, dispersant, accelerator, retarder, and polyphosphate, as compared with the core slurry, the board having a density of 34 pcf or less (e.g., 32 pcf or less, or 30 pcf or less) and a nail pull resistance of at least 65 lb (e.g. at least 72 lb) according to ASTM 473-10, method B.

(104) The method of aspect 103, wherein the cellulosic fiber is added to the dense layer slurry and core slurry in dry form.

(105) The method of aspect 104, wherein the cellulosic fiber is hammer milled.

(106) The method of any one of aspects 103-105, wherein the cellulosic fiber contains fibers that do not pass through the mesh of a U14 Clark Classifier, according to TAPPI Standard T-233 (2006 Edition).

(107) The method of any one of aspects 103-106, wherein the cellulosic fiber contains fibers having an average length of at least 1.41 mm.

(108) The method of any one of aspects 103-107, wherein the cellulosic fiber contains flakes that do not pass through the mesh of a U14 Clark Classifier, according to TAPPI Standard T-233 (2006 Edition).

(109) The method of any one of aspects 103-108, wherein the cellulosic fiber contains flakes having an average length of at least 1.41 mm.

(110) The method of any one of aspects 103-109, wherein the cellulosic fiber is added to the dense layer slurry and/or core slurry by injection of a wet pulp.

(111) The method of aspect 110, wherein the wet pulp contains from 0.5% to 10%, such as from 1% to 6%, or from 2% to 5%, of cellulosie fiber in water.

(112) The method of aspects 110 or 111, wherein the wet pulp is prepared in a hydrapulper.

(113) The method of any one of aspects 110-112, wherein the wet pulp is injected into the dense layer slurry and/or core slurry via one or more injection hose producing flow of the pulp sufficient to form enough shear force in the injection hose to uniformly distribute the cellulosic fiber in dense layer slurry and/or core slurry.

(114) The method of any one of aspects 110-113, wherein the wet pulp is mixed for an amount of time dependent on the temperature of the water in the wet pulp, and wherein it is mixed for a longer time period than the same pulp using water at a higher temperature.

(115) The method of any one of aspects 110-114, wherein an adjustment coefficient for the relationship between temperature (° F.) and pulping time according to linear regression analysis is from 0 to −0.1.

(116) The method of any one of aspects 110-115, wherein an adjustment coefficient for the relationship between temperature (° F.) and pulping time according to linear regression analysis is from −0.019 to −0.033,

(117) The method of any one of aspects 110-116, wherein an adjustment coefficient for the relationship between temperature (*F) and pulping time according to linear regression analysis is from −0,0009 to −0.0025.

(118) The method of any one of aspects 103-117, wherein the cellulosic fiber includes paper fibers, wood fibers, straw fibers, grass fibers, cotton fibers, and/or rayon fibers.

(119) The method of any one of aspects 103-118, wherein the cellulosic fiber includes paper fiber.

(120) The method of any one of aspects 103-119, wherein the cellulosic fiber includes grass fiber.

(121) The method any one of aspects 103-120, wherein the grass fiber includes bamboo fibers.

(122) The method any one of aspects 103-121, wherein the grass fiber includes hemp fibers.

(123) The method of aspect 122, wherein the grass fiber includes jute fibers.

(124) The method of aspect 122 or 123, wherein the grass fiber includes kenaf fibers.

(125) The method of any one of aspects 103-124, wherein the slurry further comprises glass fiber.

(126) The method of aspect 125, wherein the glass fiber is in an amount of from 0.1% to 1%, such as from 0.1% to 0.7%, from 0.1% to 0.5%, from 0.2% to 1%, from 0.2% to 0.7%, or from 0.2% to 0.5% by weight of the stucco.

(127) The method of aspects 125 or 126, wherein the weight ratio of cellulosic fiber to fiberglass is from 1:1 to 5:1, such as from 1.5:1 to 5:1, from 1.5:1 to 4:1, from 1.5:1 to 3:1, from 1.5:1 to 2;1, from 2:1 to 5:1, from 2:1 to 3:1, from 3:1 to 5:1, or from 3:1 to 4:1.

(128) The method of any one of aspects 103-127, wherein the slurry further comprises alum.

It shall be noted that the preceding aspects are illustrative and not limiting. Other exemplary combinations are apparent from the entirety of the description herein. It will also be understood by one of ordinary skill in the art that various embodiments may be used in various combinations with the other embodiments provided herein.

The following example further illustrates the disclosure but, of course, should not be construed as in any way limiting its scope.

### EXAMPLE 1

This example demonstrates exemplary benefits of including fibers in gypsum compositions according to principles of embodiments of the disclosure. Specifically, this example demonstrates the nail pull (“NP”) strength of boards (according to ASTM 473-10, method B) prepared with or without dry paper fiber in the board mixer and/or paper pulp in the dense layer.

The boards included both a core and dense layer. The dense layers had the same formulation as the core, since the slurries are extracted from the same mixer, and only fibers were added. The only differences between the core and the dense layer in the boards are the fibers and the densities.

To measure the impact on NP, three formulations of gypsum board were produced and tested (Boards 1A-1C). Boards 1A-1C were produced with the same dry weight target and amount of stucco. Further, Boards 1A-1C were produced with the same dosage of pregelatinized starch (i.e., 2% by weight of the stucco). In addition, Boards 1A-1C were produced with the same amount of ball mill accelerator, dispersing agent, retarder, sodium trimetaphosphate (“STMP”), and foaming agent.

Table 1 depicts the formulation for both the core and dense layer (expressed as weight % relative to the amount of stucco) for Boards 1A-1C.

TABLE 1

| Ingredient | Amount (wt. %) |
|---|---|
| Pregelatinized Starch | 2-3% |
| Ball Mill Accelerator | 1.5%-2.5% |
| Sodium Trimetaphosphate (STMP) | 0.1%-0.2% |
| Polynaphthalene Sulfonate (Diloflo) | 0.1%-1% |
| Retarder (Versenex 80) | 0.01%-0.1% |

The density of the core layer and the dense layer for Board 1A was controlled by the addition of foam (comprised of a foaming agent with water solution and air). The dense layers of Boards 1B and 1C did not contain added foam and instead contained added paper fiber as expressed in Table 2.

Boards 1A-1C differed in the amount of fiber added to each formulation. Specifically, Board LA was prepared as a control and had no fiber added to either its core or dense layer. Board 1B had paper fiber (in pulp form) added to only the dense layer. Board 1C had dry fiber added to the core formulation (Le., directly inserted into the mixer) and also paper fiber in the form of pulp added to the dense layer.

The dense layers for each of Boards 1A-1C were formulated to achieve a target dry density of approximately 50 pcf. In this respect, the fiber dosages in Table 2 are expressed as a weight percentage of dry fiber relative to the amount of stucco.

TABLE 2

| | | Dry Paper | Paper Pulp | |
|---|---|---|---|---|
| | | Fiber Added | Added to Dense | |
| Board | Dry Weight | to Mixer | Layer | Nail Pull (lb) |
| Board 1A | 1203 | 0% | 0% | 73.4 |
| Board 1B | 1197 | 0% | 1.4% | 77.6 |
| Board 1C | 1215 | 0.74% | 1.4% | 78.4 |

As seen in Table 2, Board 1A demonstrated a nail pull (“NP”) value of 73.4 lb, several pounds lower than Boards 1B and 1C. The NP performance of Board 1C (which comprised both dry paper fiber and paper pulp) was further improved over Board 1B (which solely comprised of paper pulp). Therefore, the results demonstrate that a board prepared with dry paper fiber added to the mixer and paper pulp added to the dense layer will have enhanced 2/US nail pull strength over boards prepared without its inclusion or with solely paper pulp added to the dense layer.

### EXAMPLE 2

This example demonstrates the benefits of optimizing of pulping condition to enhance the pulp quality according to principles of embodiments of the disclosure. Specifically, the example focused on how variations in pulping time, water temperature, and the consistency of the pulp affected fiber content. USG wallboard paper was blended in water for the blend time, the water temperature and the consistency listed in Table 3. For each condition, one sample was tested. No other additives were used. The blender used was the Tappi Disintegrator from Testing Machines Incorporated, currently owned by Industrial Physics, located in New Albany, Indiana.

The Techpap MorFi refers to the machine that analyzes the morphology of the paper fibers, commercially available from Industrial Physics, located in New Albany, Indiana. The Techmap MorFi was used to measure the fiber count per dry gram of pulp. The consistency refers to the percent dry weight of mass within the liquid pulp.

To measure the impact on pulp quality, the temperature was set to three different blending times (1.5 minutes, 2 minutes, 3 minutes), three different temperatures (50° F. (10° C.), 65° F. (18° C.), 80° F. (27° C.)), and two different consistencies (3.2, 5.0). The fiber content, measured in millions/g of pulp, was acquired using the Techpap MorFi from Technidyne. The results are seen in Table 3.

TABLE 3

| Blend Time | Temperature | Consistency | Fiber content, |
|---|---|---|---|
| (min) | (° F.) | (%) | millions/g of pulp |
| 1.5 | 50 | 3.2 | 5.0 |
| 1.5 | 50 | 5.0 | 4.6 |
| 1.5 | 65 | 3.2 | 5.3 |
| 1.5 | 65 | 5.0 | 5.8 |
| 1.5 | 80 | 3.2 | 5.2 |
| 1.5 | 80 | 5.0 | 6.2 |
| 2 | 50 | 3.2 | 6.3 |
| 2 | 50 | 5.0 | 5.8 |
| 2 | 65 | 3.2 | 6.2 |
| 2 | 65 | 5.0 | 6.6 |
| 2 | 80 | 3.2 | 6.4 |
| 2 | 80 | 5.0 | 6.4 |
| 3 | 50 | 3.2 | 6.4 |
| 3 | 50 | 5.0 | 6.2 |
| 3 | 65 | 3.2 | 6.0 |
| 3 | 65 | 5.0 | 6.9 |
| 3 | 80 | 3.2 | 6.9 |
| 3 | 80 | 5.0 | 6.5 |

The results from Table 3 demonstrate that higher temperatures and increased blend times are associated with improved pulping efficiency since the fiber content increased with increasing blend time and temperature. Additionally, the results indicate that consistency does not have a significant impact on pulping efficiency since fiber content did not change with consistency.

### EXAMPLE 3

This example demonstrates the benefits of incorporating paper flakes into gypsum compositions as part of the principles of embodiments of the disclosure. Specifically, the nail pull (“NP”) strength of disks prepared using various methods were evaluated.

As discussed herein, OCC refers to old corrugated cardboard. The Clark Classifier U14 screen refers to particles separated using the Clark Classifier fiber separating equipment and the attached U14 screen, commercially available from Thwing-Albert, located in Philadelphia Pennsylvania. The Clark Classifier U14 screen was used to separate long fibers and large paper flakes from shorter fibers and shorter paper flakes. Standard refers to an average fiber length of 0.772 millimeters in length; partially pulped refers to pulp which contains un-pulped paper flakes; fully pulped refers to paper pulp that was pulped leaving no paper flakes; and no treatment indicates that the original OCC pulp fibers was not separated.

Three types of disks (3A, 3B, and 3C) were prepared. The nail pull was measured for the disks, which used a 50 pcf target dry density formulation and each disk was 4 inch (10 cm) in diameter and 0,375 inch (0.95 cm) thick. Table 4 depicts the formulation for the disks (expressed as weight % relative to the amount of stucco) for disks 3A-3C. The disks were as follows: (1) disk 3A was composed of standard fully pulped OCC, with no treatment to OCC performed; (2) disk 3B was composed of long fibers collected from fully pulped OCC after separating the flakes using the Clark Classifier U14 screen; (3) disk 3C was composed of flakes collected from partially pulped OCC after separating the flakes from the remaining pulp using the Clark Classifier with a U14 screen. Regarding disk 3C, during the separation process, some long fibers remained with the flakes. These long fibers are the same quality fibers collected in condition B. The pulp consisted of 40% flakes and 60% long fibers.

TABLE 4

| Ingredient | Amount (wt. %) |
|---|---|
| Pregelatinized Starch | 0.5%-1.5% |
| Ball Mill Accelerator | 0.5%-1.5% |
| Sodium Trimetaphosphate (STMP) | 0.05%-0.20% |
| Polynaphthalene Sulfonate (Diloflo) | 0.20%-0.70% |
| Retarder (Versenex 80) | 0.02%-0.07% |
| Dry Pulp Content (Either Treated and Non | 0%, 0.5%, 1.0% or 2.0% |
| Treated) | |

The strength results are seen in Table 5.

TABLE 5

| | | | Nail Pull |
|---|---|---|---|
| Disk | Fiber Type | Percent Fibers | (lb) |
| 6A | Standard OCC | 0.0 | 25.8 |
| 6A | Standard OCC | 0.5 | 28.0 |
| 6A | Standard OCC | 1.0 | 42.4 |
| 6A | Standard OCC | 2.0 | 72.6 |
| 6B | 100% Long Fibers | 0.0 | 26.5 |
| 6B | 100% Long Fibers | 0.5 | N/A |
| 6B | 100% Long Fibers | 1.0 | 50.9 |
| 6B | 100% Long Fibers | 2.0 | 91.6 |
| 6C | 40% Flakes, 60% Long Fibers | 0.0 | 25.4 |
| 6C | 40% Flakes, 60% Long Fibers | 0.5 | 35.2 |
| 6C | 40% Flakes, 60% Long Fibers | 1.0 | 58.0 |
| 6C | 40% Flakes, 60% Long Fibers | 2.0 | 90.3 |

The results above demonstrate that nail pull values from disks formed using flakes and disks formed using long fibers performed similarly. Nail pull values formed with disks using standard fibers performed worse than disks formed with long fibers and disks formed with flakes.

In addition to the nail pull test, an image analysis was conducted on both the paper fibers and the paper flakes. The results of these analyses are seen in Table 6.

TABLE 6

| | | Fiber Mean | |
|---|---|---|---|
| | Fiber content, | length- | Fibers Mean |
| | millions/g | weighted length | Fiber width, |
| Fiber Type | of pulp | (μm) | μm |
| A - 100% Standard | 6.09 | 1296 | 24.9 |
| Fiber | | | |
| B - 100% Long Fiber | 1.99 | 2232 | 33.5 |
| C - 40% Flakes 60% | 1.25 | 2306 | 34.2 |
| Long | | | |

Table 6 demonstrates that fiber lengths and widths of conditions B and C are similar and that the primary difference between the two conditions is the flake content.

### EXAMPLE 4

This example demonstrates the benefits of combining two fiber material types as compared to a single fiber material. Specifically, this example demonstrates the nail pull (“NP”) (according to ASTM 473, method C) strength of board samples prepared with or without the combination of glass fiber and cellulosic fiber in the dense layer. The glass fiber had an average diameter of 0.25 inch and the cellulosic fiber met the standard of U14 Clark Classifier according to TAPPI Standard T-233 (2006 Edition).

To measure the impact on NP, two formulations of gypsum board samples were produced and tested (Boards 4A and 4B). Boards 4A and 4B were produced with the same paper facing materials, dosage of additives such as starch of about 1.7% relative to stucco, retarder, dispersing agent, ball mill accelerator and foaming agents. Additionally, both boards had the same dense layer densities of about 55 pcf and core densities of about 28 pcf. The dense layers had the same formulation as the core, since the slurries are extracted from the same mixer, and only fibers were added. The only differences between the core and the dense layer in both boards are the fibers and the densities.

Table 7 depicts the formulation for both Samples 4A and 4B, where the weight percentages are by weight of the stucco.

TABLE 7

| | Formulation A | Formulation B |
|---|---|---|
| Dry Weight (lb/MSF) | 1231 | 1224 |
| Paper Fiber in ELS | 1.4%-2% | 0.8%-1.3% |
| Glass Fiber in ELS | 0 | 0.3%-0.8% |
| Nail Pull (lbf) | 66.4 | 70.1 |

| | |
|---|---|
| Core Starch | 1.5%-2% |
| HRA (Heat Resistant Accelerator) | 1.7%-2.7% |
| Dispersant | 0.2%-0.6% |
| Retarder | 0.02%-0.06% |
| STMP (Sodium Trimetaphosphate) | 0.12%-0.2% |
| Foaming Agent (Soap) | 0.03%-0.07% |

As seen in Table 7, Sample 4A demonstrated a nail pull (“NP”) value of 66.4 lb, almost four pounds lower than Sample 4B. Therefore, the results demonstrate that a board prepared with paper fiber combined with glass fiber enhanced nail pull strength over boards prepared with solely paper fiber added to the dense layer.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising.” “having.” “including,” and “containing” are to be construed as open-ended terms (i.e., meaning “including, but not limited to,”) unless otherwise noted, Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of making gypsum board comprising:
preparing a slurry in a mixer, the slurry comprising water, stucco, and cellulosic fiber in an amount of 2% by weight of the stucco or less;
discharging a majority portion of the slurry from the mixer to form a core slurry;
extracting a minority portion of the slurry from the mixer to form a dense layer slurry;
applying the dense layer slurry in bonding relation to a first cover sheet;
applying a first surface of the core slurry in bonding relation to the dense layer; and
applying a second cover sheet in bonding relation to a second surface of the core slurry;
the board having a density of 32 pcf or less and a nail pull resistance of at least 65 lb according to ASTM 473-10, method B.

2. The method of claim 1, wherein cellulosic fiber is not added to the discharged core slurry.

3. The method of claim 1, wherein the cellulosic fiber contains fibers that do not pass through the mesh of a U14 Clark Classifier, according to TAPPI Standard T-233 (2006 Edition).

4. The method of claim 1, wherein the cellulosic fiber contains flakes that do not pass through the mesh of a U14 Clark Classifier, according to TAPPI Standard T-233 (2006 Edition).

5. The method of claim 1, wherein the cellulosic fiber is included in a wet pulp that contains 0.5% to 10% of cellulosic fiber in water and it is added to the dense layer slurry and/or core slurry by injection of the wet pulp.

6. The method of claim 5, wherein the wet pulp is prepared in a pulper.

7. The method of claim 5, wherein the wet pulp is injected into the mixer via one or more injection hose producing flow of the pulp sufficient to form enough shear force in the injection hose to uniformly distribute the cellulosic fiber in dense layer slurry and/or core slurry.

8. The method of claim 6, wherein the wet pulp is mixed in the pulper for an amount of time dependent on the temperature of the water in the wet pulp.

9. The method of claim 8, wherein an adjustment coefficient for the relationship between temperature (° F.) and pulping time according to linear regression analysis is from 0 to −0.1.

10. The method of claim 1, wherein the cellulosic fiber includes paper fiber.

11. The method of claim 1, wherein the cellulosic fiber includes grass fiber, containing bamboo fibers, hemp fibers, jute fibers, kenaf fibers, or any combination thereof.

12. The method of claim 1, wherein the slurry further comprises glass fiber.

13. The method of claim 12, wherein the glass fiber is in an amount of from 0.1% to 1%, such as from 0.1% to 0.7%, from 0.1% to 0.5%, from 0.2% to 1%, from 0.2% to 0.7%, or from 0.2% to 0.5% by weight of the stucco.

14. The method of claim 1, wherein the slurry further comprises alum.

15. A method of making gypsum board comprising:
preparing a core slurry comprising water, stucco, foaming agent, and cellulosic fiber and strength-enhancing starch in an amount of 4% or less by weight of the stucco;
preparing a dense layer slurry comprising water and stucco;
adding cellulosic fiber to the dense layer slurry in an amount of 2% by weight of the stucco or less;
applying the dense layer slurry in bonding relation to a first cover sheet;
applying a first surface of the core slurry in bonding relation to the dense layer; and
applying a second cover sheet in bonding relation to a second surface of the core slurry;
the board having a density of 32 pcf or less and a nail pull resistance of at least 65 lb according to ASTM 473-10, method B.

16. The method of claim 15, wherein the weight ratio of the cellulosic fiber provided in the dense layer slurry relative to the core slurry is at least 1.8 (e.g., from 1.8 to 4.5, such as from 1.8 to 4, from 1.8 to 3, from 1.8 to 2.5, or from 1.5 to 2.3).

17. The method of claim 15, wherein the strength enhancing starch is included in an amount that is from 30% to 200% more than the amount of the fiber.

18. A method of making gypsum board comprising:
preparing a core slurry comprising water, stucco, foaming agent, and cellulosic fiber in an amount of 0.5% to 1.5% by weight of the stucco;
preparing a dense layer slurry comprising water, stucco, and cellulosic fiber in an amount of 0.7% to 2% by weight of the stucco, the dense layer slurry excluding foaming agent;
applying the dense layer slurry in bonding relation to a first cover sheet;
applying a first surface of the core slurry in bonding relation to the dense layer; and
applying a second cover sheet in bonding relation to a second surface of the core slurry; wherein:
the dense layer slurry preferentially contains a greater concentration of the cellulosic fibers than the core slurry,
the dense layer slurry includes the same or lower amount of starch, dispersant, accelerator, retarder, and polyphosphate, as compared with the core slurry,
the board having a density of 32 pcf or less and a nail pull resistance of at least 65 lb according to ASTM 473-10, method B.

19. The method of claim 18, wherein the cellulosic fiber is included in a wet pulp containing 1% to 6% of cellulosic fiber in water, wherein the wet pulp is injected into the dense layer slurry and/or core slurry via one or more injection hose producing flow of the pulp sufficient to form enough shear force in the injection hose to uniformly distribute the cellulosic fiber in dense layer slurry and/or core slurry.

20. The method of claim 18, wherein the cellulosic fiber includes paper fiber and/or grass fiber containing one or more of the following: bamboo fibers, hemp fibers, jute fibers, kenaf fibers, or any combination thereof.
